(19) United States
(12) Patent Application Publication
(10) Pub. No.: US 2025/0296715 A1
(43) Pub. Date: Sep. 25, 2025

(54) Drone Port

(71) Applicant: Inteliports Limited, Southampton (GB)

(72) Inventor: Dennis Majoe, Hampshire (GB)

(21) Appl. No.: 18/863,038

(22) PCT Filed: May 5, 2023
(86) PCT No.: PCT/GB2023/051191

§ 371 Date: Nov. 5, 2024

(30) Foreign Application Priority Data
May 5, 2022 (GB) 2206541.1
Oct. 12, 2022 (GB) 2215044.5

(51) Int. Cl. B64U 80/10; B25J 11/00; B64F 1/228; B64U 80/25; B64U 80/30; B64U 80/40; B64U 101/64; B64U 101/70

(52) U.S. Cl. CPC B64U 80/10; B25J 11/008; B64F 1/228; B64U 80/30; B64U 80/25; B64U 80/40; B64U 2101/64; B64U 2101/70; B64U 2201/10

(57) ABSTRACT

A drone port has a set of autonomous transport robots (or rovers) that can collaborate with each other, are automated and can provide a scalable drone service unit or system within an existing building. The rovers are able to transport or move the drones, such as to and from a landing, take-off or drop-off area. The rovers can transport or move (drone) packages/payloads and load/unload the packages onto, or from, the drones.

### FIELD OF THE INVENTION

This invention relates to the field of drone port automation. Specifically, the invention concerns the field of automated drone (or Unmanned Aerial Vehicle, UAV, the terms are used interchangeably) systems for drone delivery and/or (UAV) parcel handling logistics.

### BACKGROUND OF THE INVENTION

Recently there has been growing interest in the use of drones to deliver parcels either in the drones (medical space, e-commerce or military). For this technology to be competitive with vans and other ground transport, there will be the need for improving efficiency and reducing cost.

Drone technology has focused on the problems of flying and associated regulations. However, less attention has been given to what happens before the drone takes off with a parcel and when it lands with a parcel. First and foremost, one needs a landing and take-off point which ideally can also handle parcels for drone delivery and handle parcels that have been received by drone. We refer to this site as a drone port.

Drone ports can be sited strategically at different locations in both rural and urban geographies. In dense urban areas land cost is high and commercially viable drone ports must be designed to account for this.

When drones are to be used in this context of drone ports, the handling of drones, parcels and flight scheduling could be achieved using human operators. However, the largest costs in drone ports will usually be associated with the amount of human labour and the amount of land on which the drone port is sited. Drone ports that use more land to garage and interact with the drones will require more land at more cost, therefore compact small foot-print drone ports are desirable.

Since the revenue per delivery must be kept as low and as affordable as possible given competing modes of transport, commercially viable drone port revenues will most likely require extremely high throughput of drones and parcels on a continuous basis.

With humans carrying out the mundane tasks of loading and unloading drones, as well as charging and garaging the drones, over extended periods of work, the risk of human error may be significant. Moreover, there exists a danger to humans interacting with drones whose protruding propellers and frames are not designed to meet human ergonomic needs, and this represents another risk requiring mitigation.

A fully autonomous drone port solution may provide a solution to many of these issues.

The invention is a multiple fully autonomous drone (UAV) port, providing parcel (or package or payload, the 3 terms are used herein interchangeably) and/or drone (UAV) handling service(s).

In order to ensure our invention was robust for the real world we considered other similar concepts in existence today such as the automated warehouses of large e-commerce vendors.

Our research has lead to some key design improvements that pertain to item handling such as automated warehousing and/or automated drone ports:
The design should reduce the need for major capital investment, so automation should be kept effective but at low cost.
Modularity of the automation is desirable so that throughput can scale easily, e.g. by adding devices rather than investing in a fixed capacity system.
Automation devices and the actual/physical building can be kept separate so that changes to the building in the future reduces down time.
The land footprint should be as low as possible with a compact structure.
Scalability should be possible by taking advantage of modularity.
Ability to increase throughput with human supervision to start with but phasing to full automation (e.g. in the medium term).
Parcel and/or drone tracking in the drone port are suitably in real time.
A range of parcel sizes and/or weights should be handleable.

The drone port solution of this invention is aimed at compactness and modularity. The physical structure and/or automation can be kept as independent components.

In the invention the transportation of parcels and drones may require or provide a high level intelligent wheeled robots and/or rovers, e.g. that can physically interact with the parcel(s) and drones, suitably with high accuracy and dexterity.

Such rovers can be able to recognize, pick up, handle and/or drop off parcels, wherever required. Such devices can have local embedded intelligence, e.g. to perform tasks independently.

Following Civil Aviation Authority regulatory best practice, drones should, where possible, operate away from the ground so as to avoid contact with humans, animals and property. Therefore, a drone port ideally needs to have at least one floor, where a roof can provide a landing, drop-off and/or take-off area.

In any one or more drone port there may be several rover(s) for drone and/or parcel handling. There may also be one or more lifts, charging systems and/or location systems. For an optimal solution all these devices preferably collaborate efficiently, e.g. in order to spend the least time and energy to perform their required functions.

Multiple drone ports can form a logistics network. Multiple drone ports may collaborate and fully understand the progress of drone and parcel handling at other ports, so as to be able to schedule efficient services that take account of the overall status at all drone ports. Thus, a collaborative control system may be required that integrates the tasks of otherwise independent robots.

A drone port network with such specific combination of features is not reflected in any prior art.

It is therefore a purpose of the present invention to provide a scalable modular architecturally compact drone port solution that can include human operators assisted by automation but with the medium-term goal being to deliver full autonomy.

It is another purpose of the present invention to provide a solution that can be relatively inexpensively afforded thanks to the specification of the rover robots to full fill a range of roles at low cost.

Further purposes and advantages of this invention will appear as the description proceeds.

### SUMMARY OF THE INVENTION

In a first aspect of the invention there is provided an automatic system for handling parcel(s) and drone(s) (or UAVs) within a drone (UAV) port in a (physical) building. The system may comprise, such as within one UAV/drone port, one or more of the following:
a. (a set of) autonomous mobile robot(s), or rover(s);
b. at least one (one-story) structure with a (e.g. roof top) for drone/UAV landing, (drone) take-off and/or parcel drop-off;
c. (optionally at least one) lift to (enable) transport, e.g. between vertical level(s);
d. (at least one) network of multi-level corridor(s) connected to a lift (shaft) which can provide storage (garaging) and/or (electric) charging (to incoming drones);
e. (at least one) network of multi-level corridor(s) connected to a lift (shaft) which can provide storage (e.g. locker space) for incoming and/or outgoing parcel(s); and/or
f. a (collaboration) computer and/or server, which can comprise a central processing server, suitably configured to communicate with one or more of the the robot(s), lift(s) and/or drone(s) (and suitably other processor(s) and/or sensor(s) that may be located (spread out) in (e.g. each of) the (networked) drone port(s).

The drone port system may comprise a drone port building and/or may be designed to provide (compact and/or ergonomic) corridor(s) for locker(s) and garaging and/or direct lift access. The only automation may be the lift or lifts (if present) and/or the rover and/or robot(s).

This design may allow for modularity, scalability and/or flexibility, e.g. during changes in demand and/or modification of the building(s).

The rover and/or robot(s) may perform different tasks, however they may all be based on or in a (standard) transport base or hub, e.g. which can have different actuators and/or effectors.

The rovers (or robots, the terms are used interchangeably) may comprise a (set of) on-board sensor(s), processor(s), software and/or other electronics. These may besuitably configured to provide them with two-dimensional navigation and/or travel capabilities, that preferably enable them to navigate and/or travel (e.g. autonomously) to and from or both along the drone port roof (landing or take off area), the drone port floor and/or the drone port corridors that may provide parcel storage/lockering and/or the drone port corridor(s) that may provide drone storage (e.g. garaging and/or charging).

The (modular) architecture of the system may allow integrating a lift, corridor(s) and/or rover(s) into at least one (already in-use) structure and/or facility, such as a (vacant) wing of an existing building, such as with roof access, or in a structure on the roof (of the building). This may offer a high level of implementation flexibility and/or ongoing scalability by not needing a dedicated building to begin with, but instead using an existing structure.

Embodiments of the invention comprise at least one parcel acceptance and/or receiving station or area, which can comprise one or more of a:
processor,
user interface terminal screen;
parcel April Tag;
QR code and/or RFID scanner;
weighing scale or means; and/or
software (dedicated to interface with other processors in the system).

This may allow a human or automated operator to drop off a parcel at the acceptance or receiving station (thereon), such as for delivery to another drone port. The system may then perform (the tasks of) drone and/or parcel handling, flight scheduling and/or (final) take off.

In a second aspect the or each of the rovers or robots (of the system) may comprise one or more of the following:
a. a (base) chassis, e.g. with (meccanum) wheels and/or motors and optionally motor drivers (such as providing 2D and/or 3D omnidirectional movement);
b. at least one (e.g. RGB) camera;
c. at least one (e.g. depth) sensor, e.g. based on stereo vision and/or time of flight;
d. at least one battery (or system);
e. at least one (e.g. computer) processor system;
f. at least one (wireless) data communication system;
g. at least one visual marker and/or energy transmitting/receiving system or beacon, such as (or means to allow) the location and/or orientation of the rover/robot, such as from at least one remote sensor and/or transmitter;
h. at least one parcel carrier (e.g. top panel), such as where a parcel is to be located or transported (carried);
i. at least one lift which can e.g. raise and/or lower the parcel (e.g. a carrier top panel);
j. at least one mover/transporter/pusher mechanism that can e.g. push/move the parcel off, or away from, the top panel;
k. at least one (e.g. actuator) system, e.g. to contact and/or elevate a drone (off the ground from underneath);
l. at least one extension arm, e.g. to pull/move a parcel (e.g. on the ground) towards (or away from) the rover and optionally onto the top surface (via a gradient wedge); and/or
m. at least one (e.g. belt) conveyor, e.g. to pull/move a parcel (on the ground) towards the rover and optionally onto the top surface (via a gradient wedge);
where the components i. to m. are all optional, such as depending on the intended main function of the rover.

In some embodiments of the invention the extension arm mechanism can comprise at least one actuator linear actuator, for example at least one steel tape held on motorized reel, e.g. which when reeled out may project away from the rover at different angles (so that the end of the arm can be placed behind the parcel with the aim being to pull the parcel towards the rover).

The pusher mechanism may comprise a linear actuator, for example at least one steel tape held on motorized reel which, when reeled out, can project away from the rover.

This can be used to push (or pull) the parcel, thus causing it to pivot at the rear held by the arms such that the parcel can easily be pulled onto the gradient wedge without jamming.

The software in each robot may comprise (dedicated) software and/or algorithms that may be configured to enable the robot to execute (one or more of):
navigation,
driving and/or
(fine) positioning procedures,
   for example, in order to
pick up and put down drones,
transport parcels and deliver them, and/or
load parcels onto drones, e.g. using the lift which may have pushed the top surface upwards and the parcel towards the drone undercarriage so that the parcel can enter the under carriage cargo bay or parcel retention system.

The processor of each rover may be provided with path navigation data, such as by the collaborative server, so as to navigate the drone port and/or corridors lift and/or rooftop.

### DETAILED DESCRIPTION OF EMBODIMENTS OF THE INVENTION

The invention relates to at least two automated drone ports, each may consist of multiple multidirectional autonomous rover/robots, drones and lift or lifts, that may be deployed by a central collaborative server computer.

Each drone port may have one or more of the following element(s):
at least one lift, such as comprising at least one lift floor,
at least one motorized unit, suitably to raise and lower the lift (via pulleys or similar),
at least one processor, suitably to process commands and control lift floor and/or height,
at least one braking system, suitably to secure lift at a level, and/or
at least one corridor level sensor and/or at least one data communications route, suitably to and/or from the collaborative server.

To respond to commands and/or carry out tasks the (optional) lift may have (at least one) operating software or program, suitably to perform the raising lowering and/or stopping of the lift floor, e.g. at levels as directed by remote commands.

The rovers may have or achieve 3-dimensional movement around the drone port utilizing their 2D navigation and use of the lift or lifts. There may be linear actuator(s) to push up, forward, backward and/or forward or backward in a rotation arc. This may allow the rovers t (flexibly) handle collection, transport and/or drop off of drone(s). e.g. of various shapes and/or sizes.

Some of the features of the invention that makes the system different from existing systems are:
The collaborative server computer can control the tasks of lifts, drones and/or rovers, suitably in real time, e.g. at least one drone port (when deliveries are to be made to or from drone port such as to any non drone port destination).
The collaborative server computer may control the tasks of lifts, drones and/or rovers, suitably in real time, e.g. at a plurality of drone ports, e.g. when deliveries are to be made between drone ports and any non drone port destination, optionally synchronizing multiple locations, for example so that the parcel transport network works optimally.
The collaborative server computer may use data from beacons and/or markers to locate the position and/or orientation of drone(s), parcel(s), and/or rover(s) and so may provide high level path navigation information for broad navigation tasks, e.g. while specific local navigation and obstacle avoidance is carried out by each rover or drone or lift.
Unlike parcel handling systems using conveyor belts, the rover based system may “plug and play” into any format of lift and corridor shelving design.
Since rovers can be leased, or rented, the expansion and contraction of the service provided by the robots can change with demand and provide a cost effective alternative to static inbuilt hardware.
In addition, the invention can be an expandable system whose modularity allows a high level of implementation flexibility and ongoing scalability. By adding more corridors and more rovers, clients can mix and match depending on their budget and can economically increase/decrease scalability in peak or off season.
The lift corridor multilevel design may deliver a (high) drone, parcel storage density on a small land footprint meaning lower land purchase or lease/rental costs.

The invention comprises the following components, which will be described in detail herein below.

The (optional) lift and/or rover(s) may constitute intelligent robots in their own right, suitably that their local processing may allow them to carry out tasks, e.g. with feedback from local or system wide sensors. However, they may operate at a lower singular level performing tasks on their own with little or no awareness of inter robot collaboration. Collaboration may be gained through the use of a centralized collaborative server.

The collaborative server CS may be a software application running e.g. on a dedicated computer which has communications to some or all of drone ports and associated rovers and lift or lifts, location system sensors at the drone ports, as well as all drones. The communications allow the collaborative server to determine in real time the status of all rovers, lifts, drones and also enables the collaborative server to send commands to each lift, rover or drone. These are high level commands which the rover, lift or drone should perform.

A high-level command for example would be to instruct a rover on the roof top to go from its current position to the lift. The CS may also send a command to the lift to go to the roof top level. The rover does not need any more commands as it can move to the lift using its own software application and does so until it has arrived at the lift door. Likewise, the lift using its software application performs the move to the top floor automatically. The CS, having established the rover and drone are at the correct places, can instruct the lift to open its door and then instruct the rover to enter the lift once the door is open.

For a network of drone ports to collaborate, the CS monitors and commands the robots at all ports simultaneously. When a parcel is to be sent from one port to another, the CS handles the scheduling of the flights in association with external applications that provide flight path approval such as an automated unmanned traffic management system.

In the case where there are 4 drone ports collaborating to move parcels across a road traffic congested city, each drone port would be serviced by the minimum of one lift, one parcel lockering, one rover, one parcel pickup rover, one drone garaging rover, one charging station for either a drone or a rover. In order to coordinate this the CS is faced with approximately 70 status variables and is required to make decisions to signal approximately 20 commands in real time with constant monitoring between each command being sent.

The CS should deal with both binary and continuous variables such as flight distance, battery charge levels, position of a rover relative to the required destination. These calculations and decisions must be made to both realize the logic behind the systems function as well as to optimize the time taken to deliver parcels.

The software coding of the CS may require that developers figure out the sequence of commands that not only correspond to the correct logical reaction to changes in status, but also achieve parcel delivery in an optimal way.

As it is intended the CS control many more ports, not only is the software coding problem impossible to solve by human developers, but the number of conditional statements required which exponentially rise. For example, a look up table approach will require many terabytes of memory to store the all the states and processing would not be achieved in real time.

The number of commands and status variables may grow as more drones, rovers and lifts are incorporated. At the level of four drone ports it becomes almost impossible for a human developer to recreate the logic and optimization.

For this reason, in this invention the CS may be based on a three-phase approach for software development.

In the first phase the drone ports lift, rovers, drones, charging stations flights, parcel delivery initiation are all simulated to a high level of fidelity in software. Since a method is to be used where the assumption is that the current state of the drone ports and robots is independent of a previous state, that is there is no state memory, and is representable by a Markov decision process, then all status data must implicitly include single point measured states. Thus, status which may require past states in order to be realized such as acceleration, velocity must be explicitly provided.

All the above and other characteristics and advantages of the invention will be further understood through the following illustrative and non-limitative description of embodiments thereof, with reference to the appended drawings.

### DRAWINGS

FIG. 1a, shows the drone port from a top diagrammatic view. The lift 1, is adjacent to corridors at ground level, where corridor 2 may be for drone garaging, corridor 4 may be for drone charging and maintenance and corridor 3 is for parcel drop off and collection.

FIG. 1b, shows an area 5, which can (then) surround 4 (see FIG. 1c).

The area 5 represents at least one area where a human operator may work and include a parcel receiving area or computers and other electronic systems can be housed.

The lift and corridors adjacent to the lift 1, represented by 2, 3, 4 are preferably multi-level so that the lift can interact with multi-level corridors increasing capacity.

FIG. 2 shows the plan view of the roof top. The area 1 is kept for the lift. Areas 6 and 7 may be used to garage the rovers. The six remaining areas 8, can be used for drone landing, take-off and parcel drop off.

FIG. 3 shows how the modular architecture allows easy scalability as lift and corridor T shaped modules are tessellated together. In this case at least one area 9 and 10 can be used for human use, parcel preparation or for housing of computational and communication devices, power generation and battery systems, spare parts, climate control systems. The depth of tessellation is not restricted to that shown.

FIG. 4 shows the lift, the corridors and a human parcel porter dropping off an item.

The porter is shown placing the parcel onto a rover. The porter indicates via a mobile app that the parcel is ready for transfer. After weighing and scanning the parcel the rover takes the parcel into the corridor system, where certain corridor levels allow for parcels incoming and others for lockering.

FIG. 5 shows the internal components of the rover chassis.

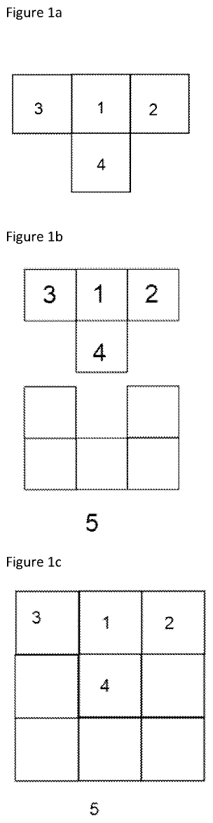

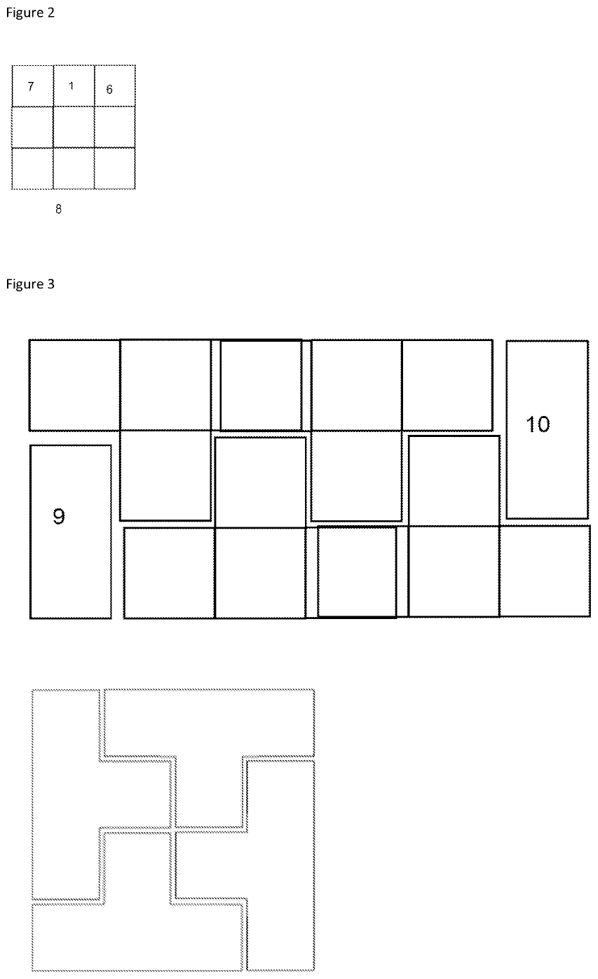

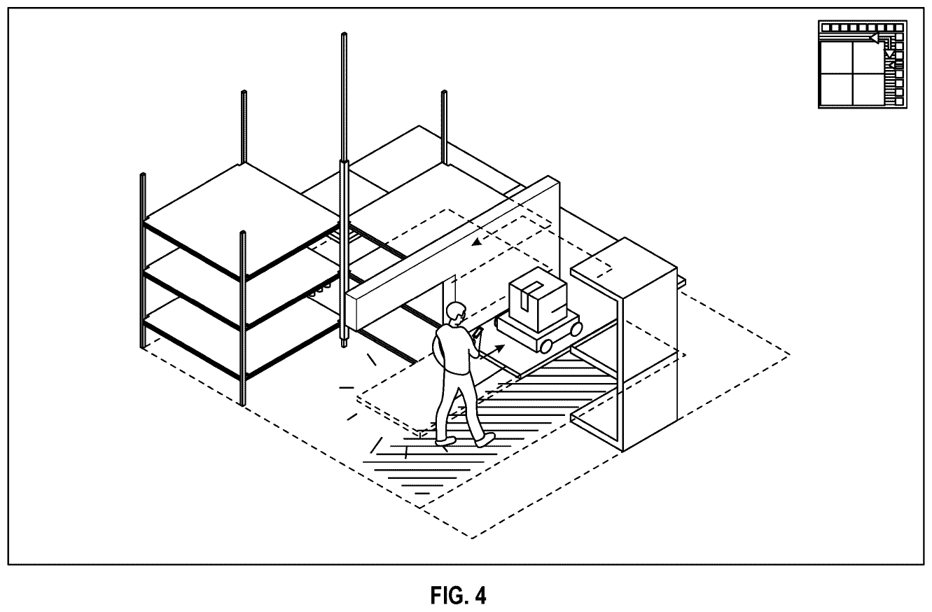

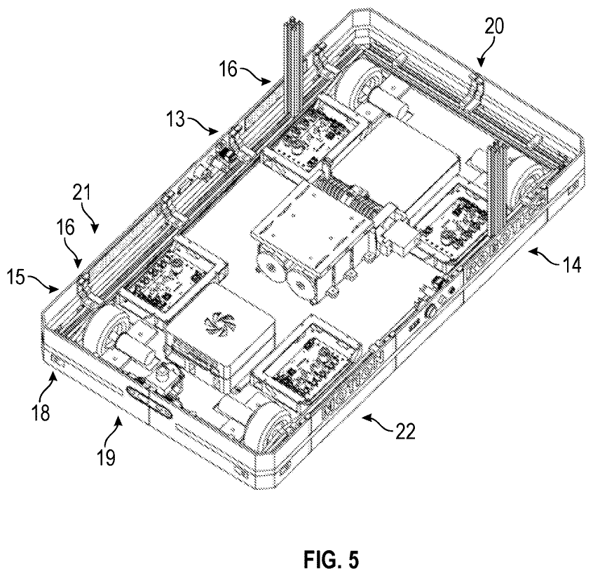

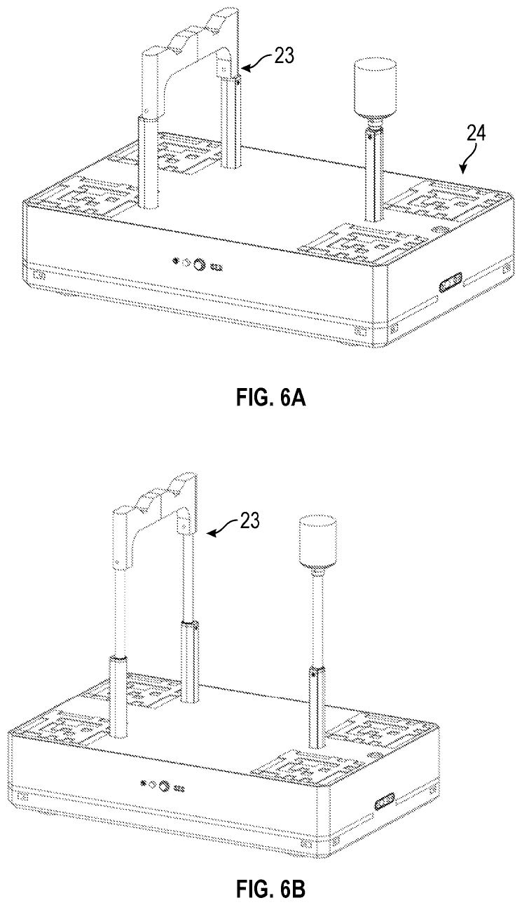

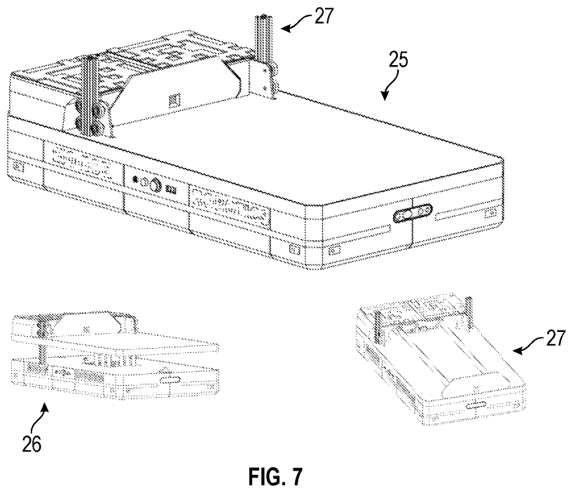

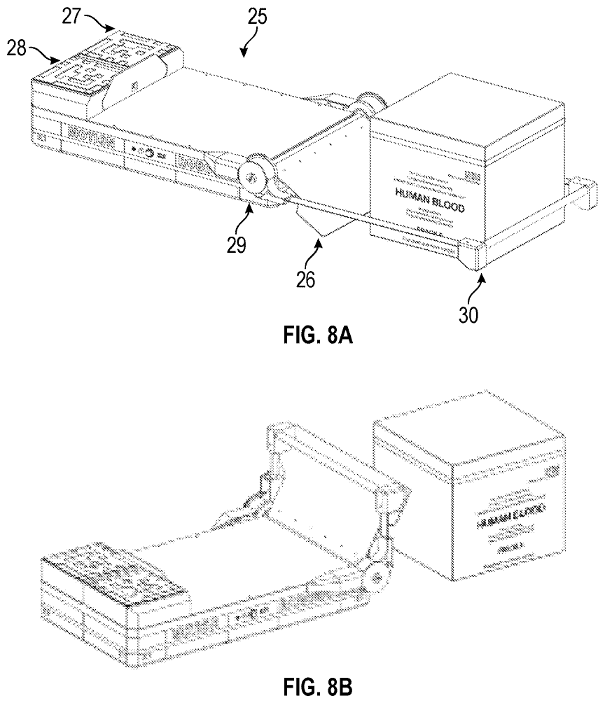

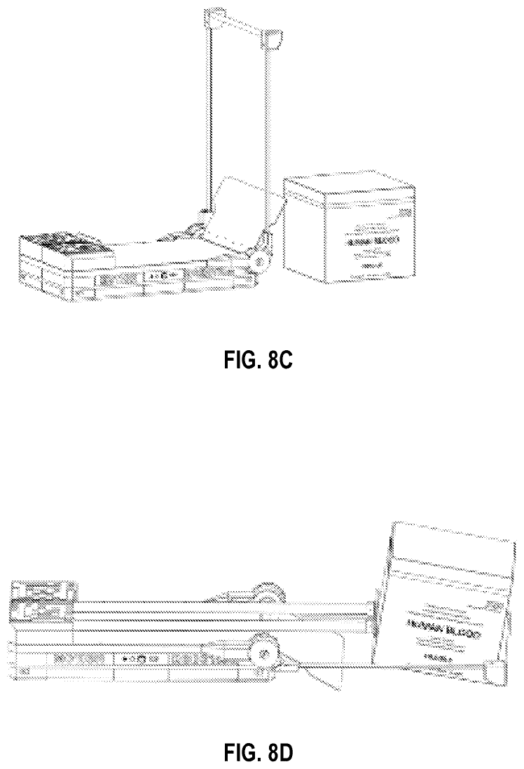

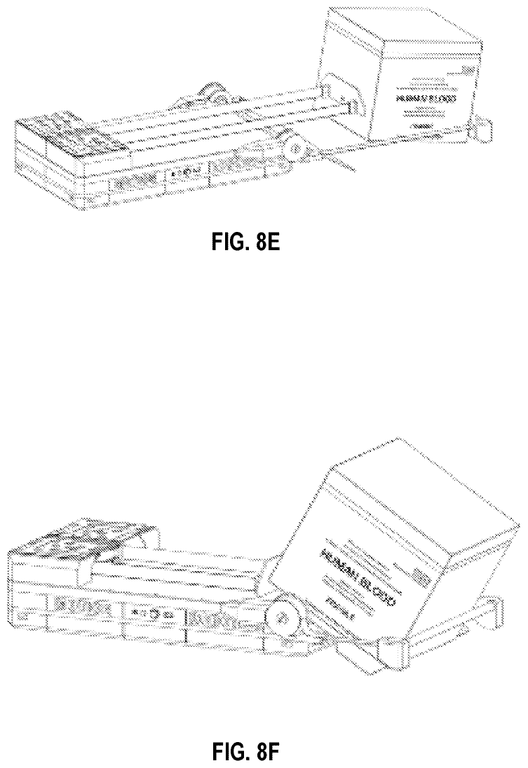

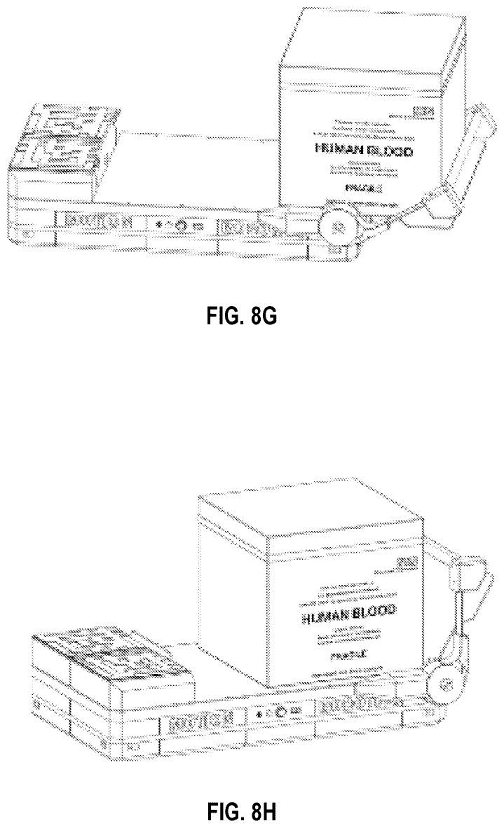

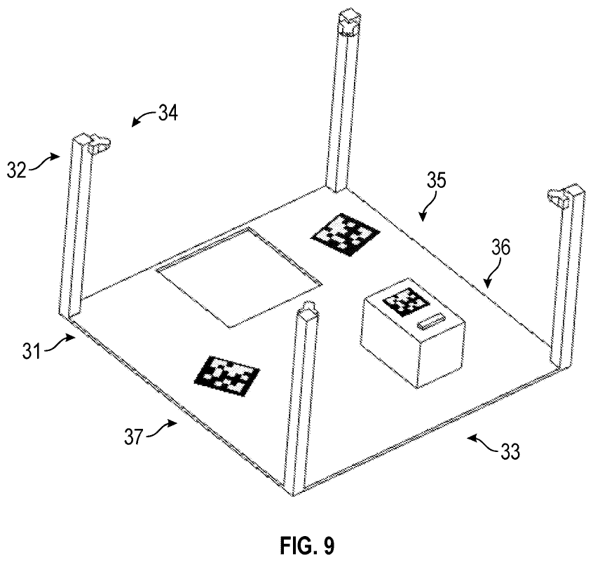

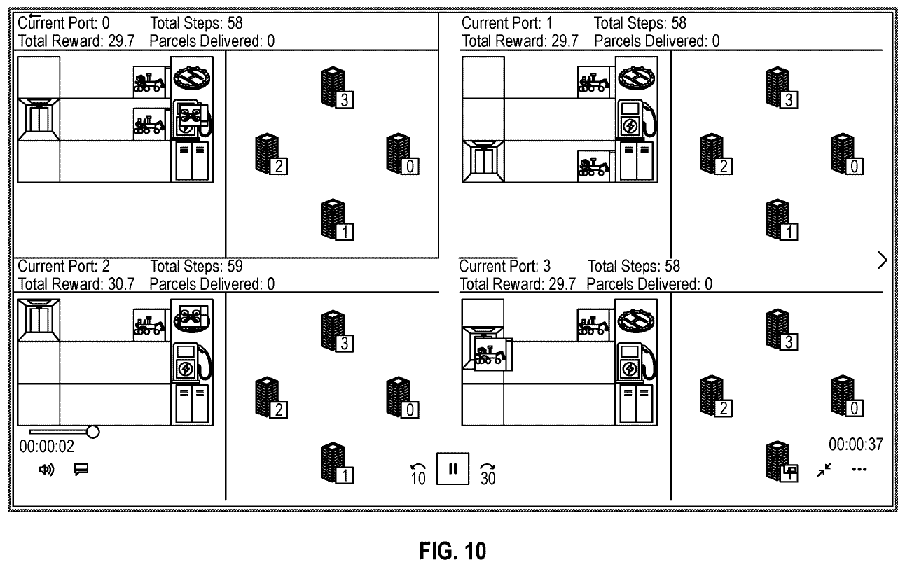

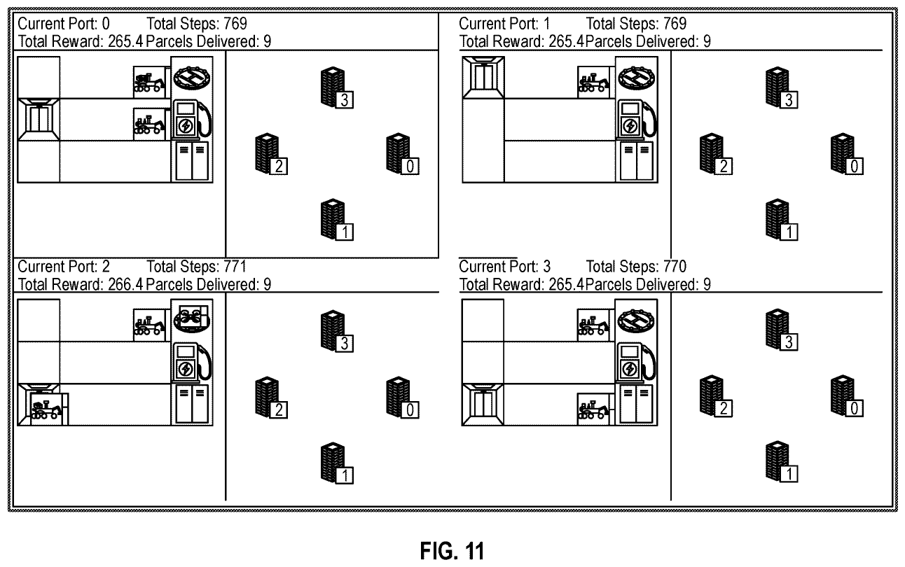

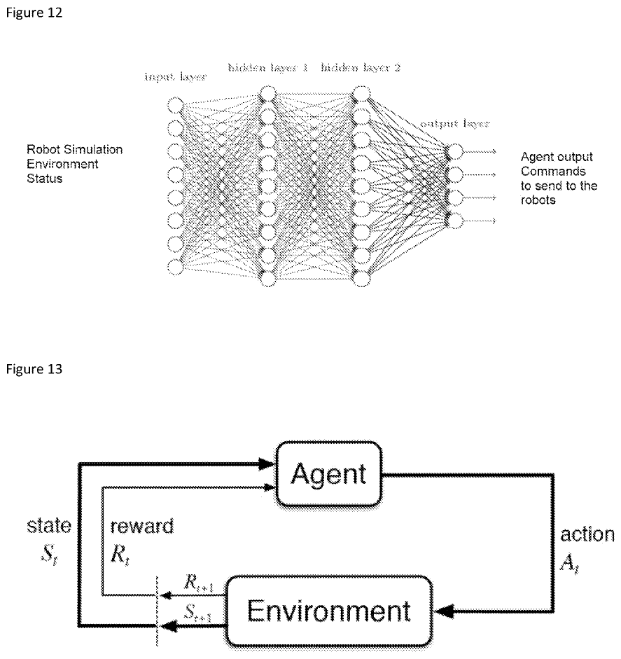

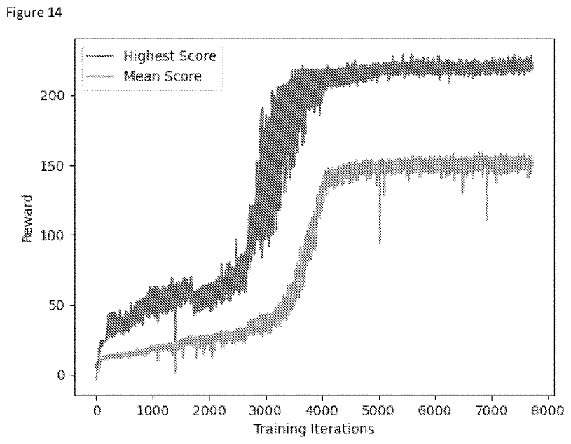

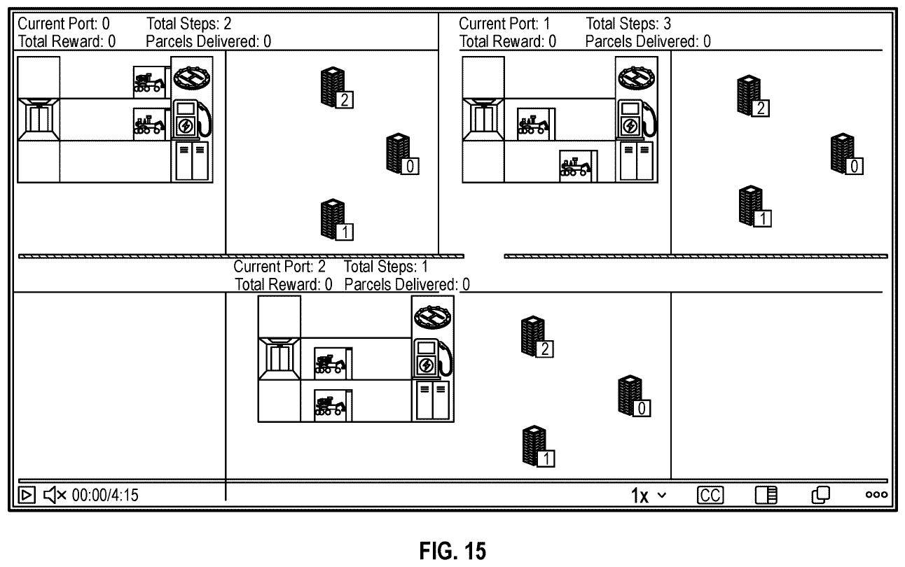

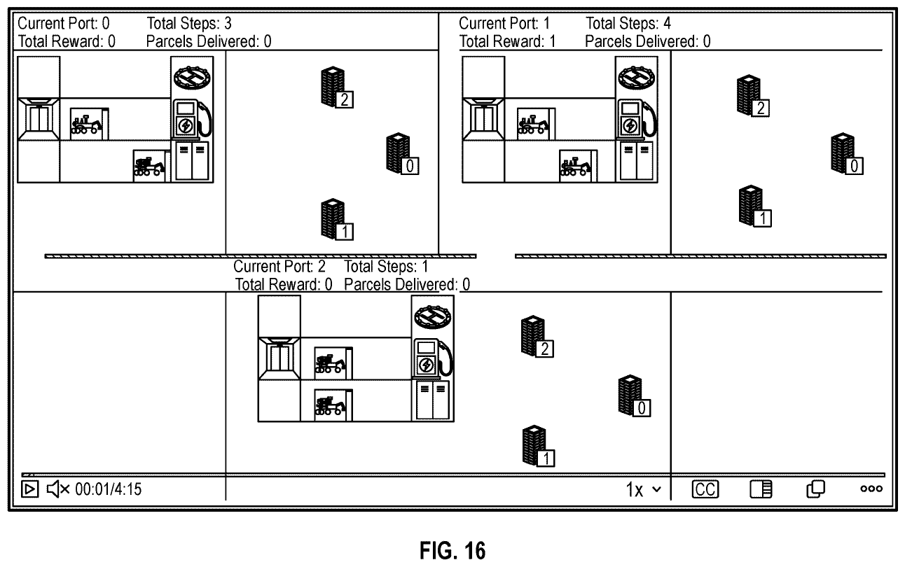

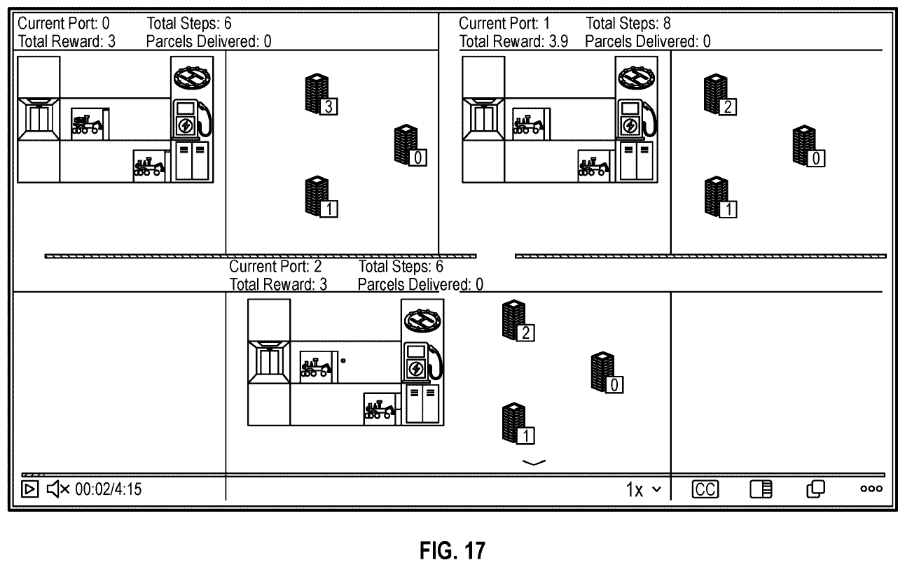

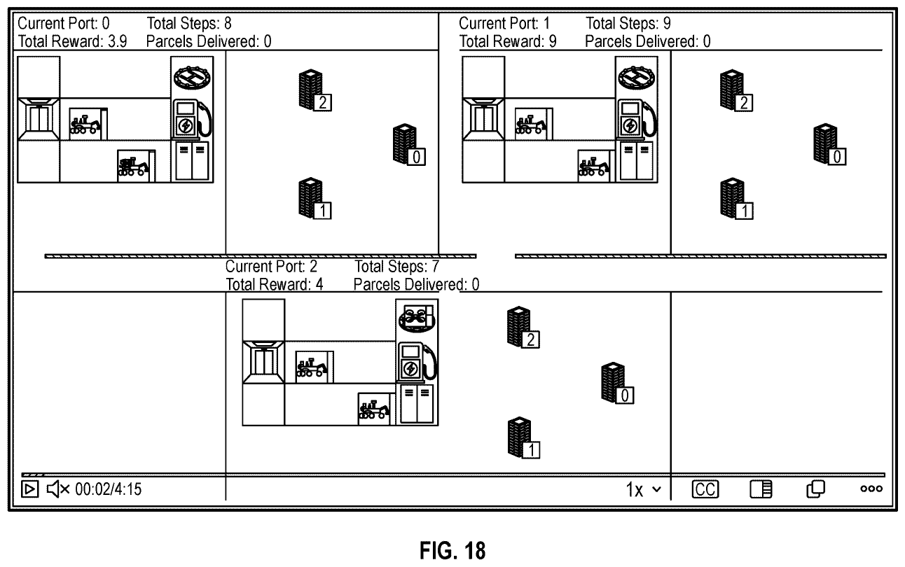

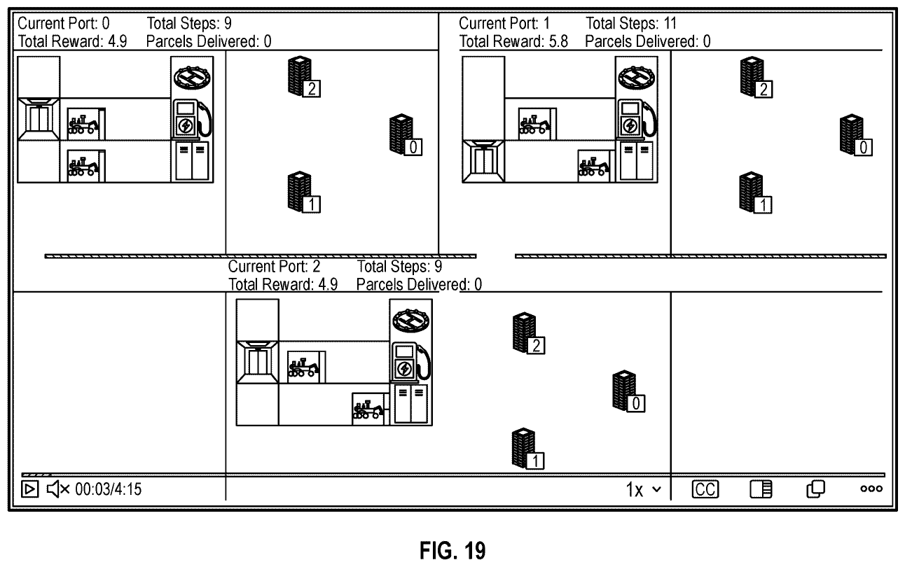

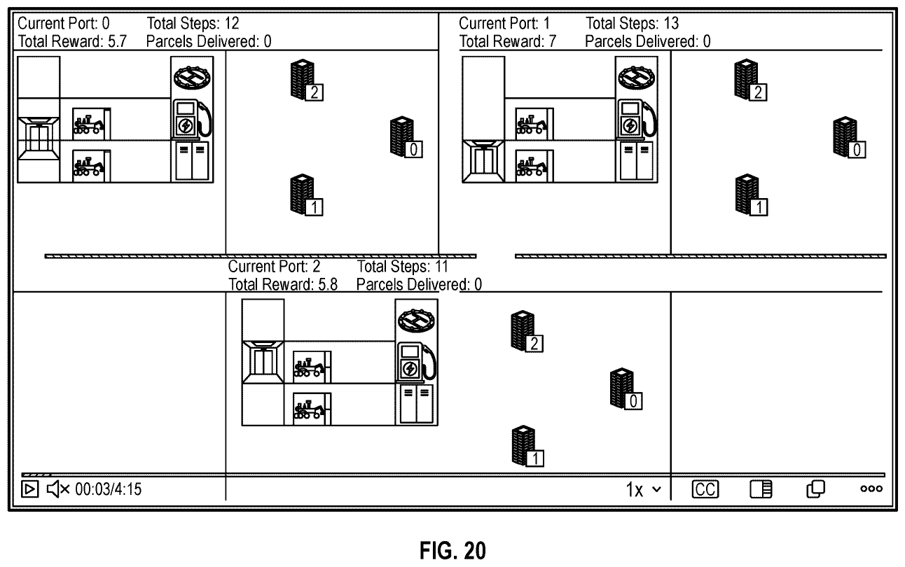

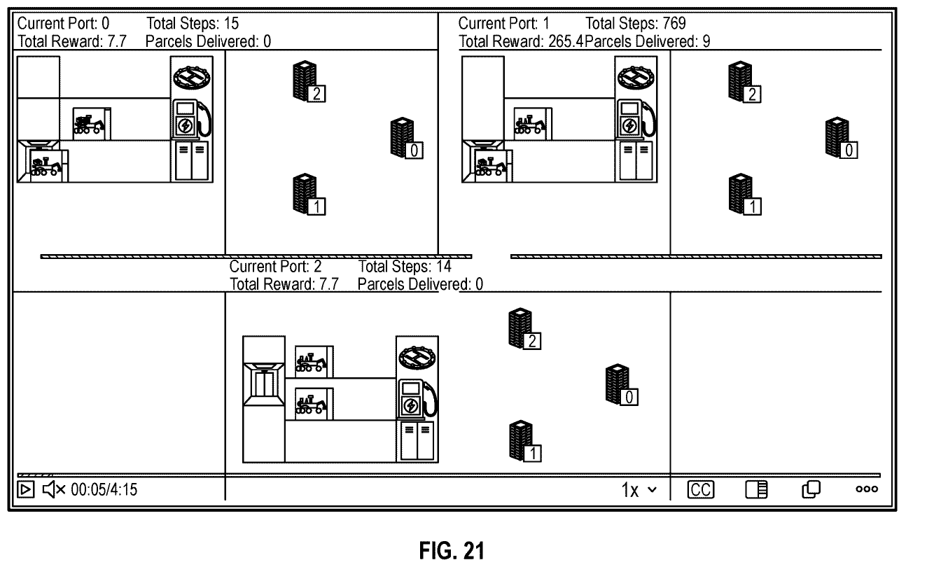

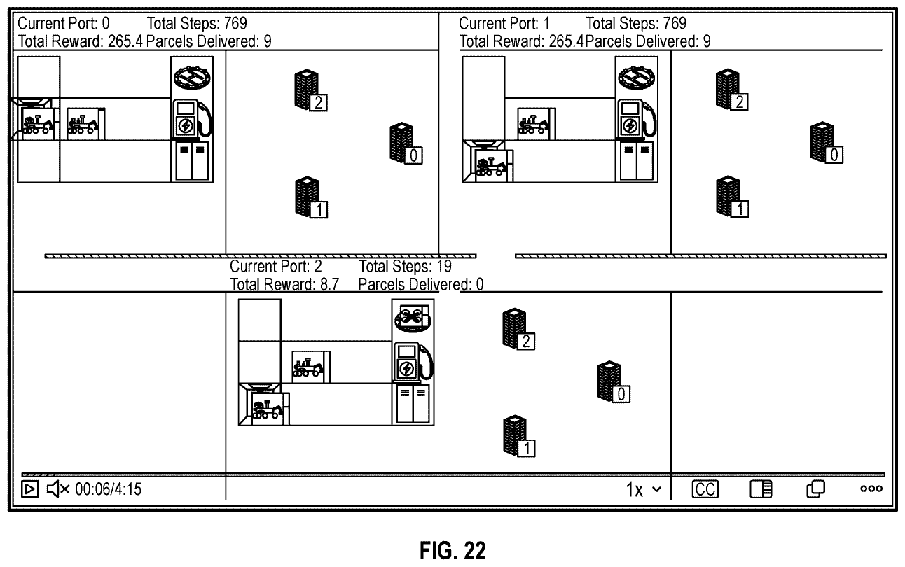

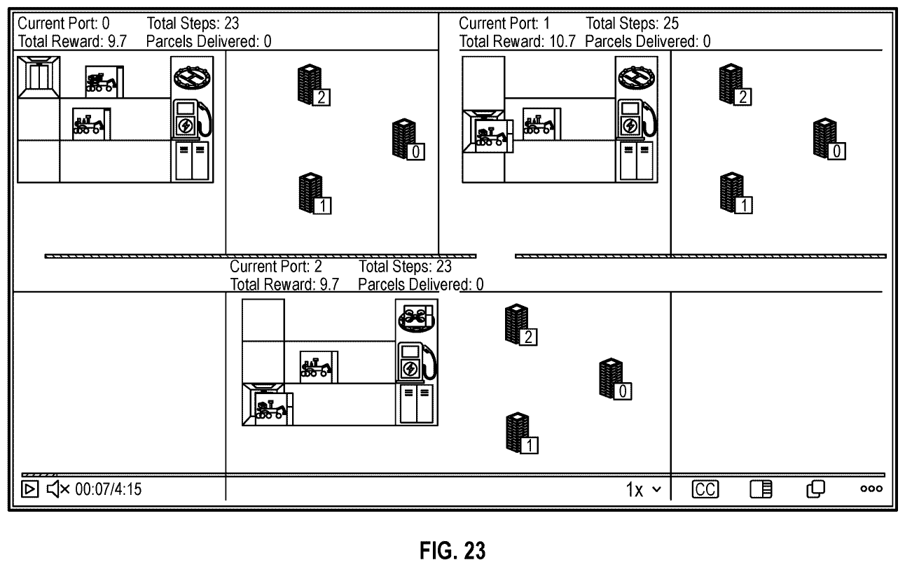

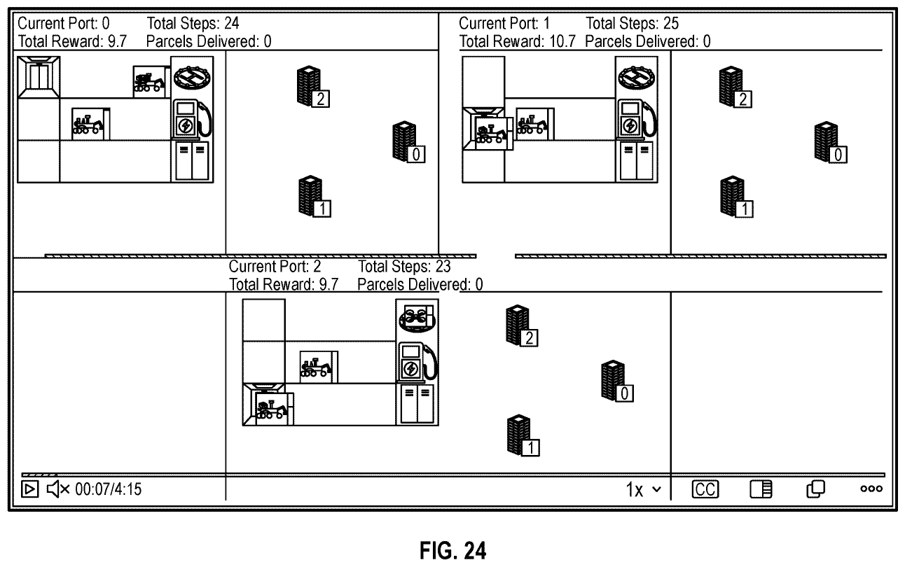

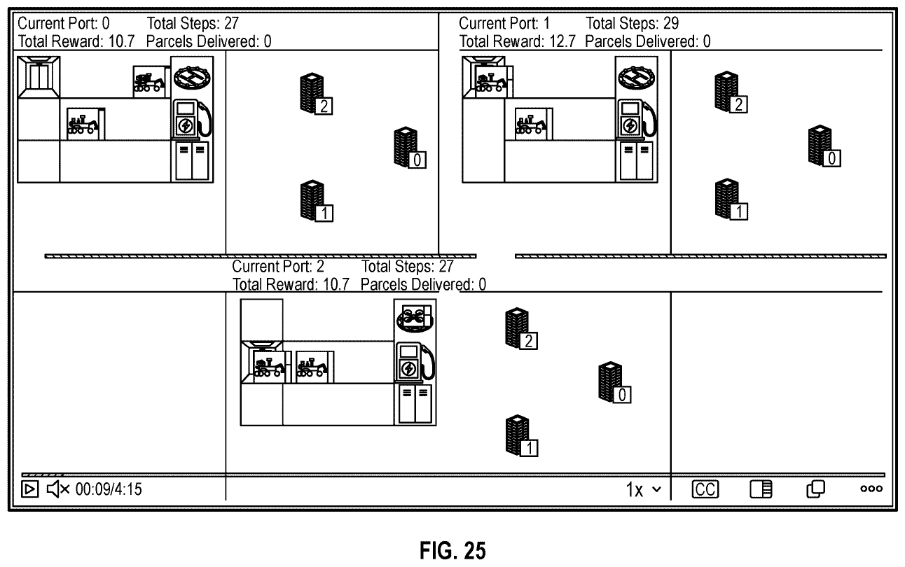

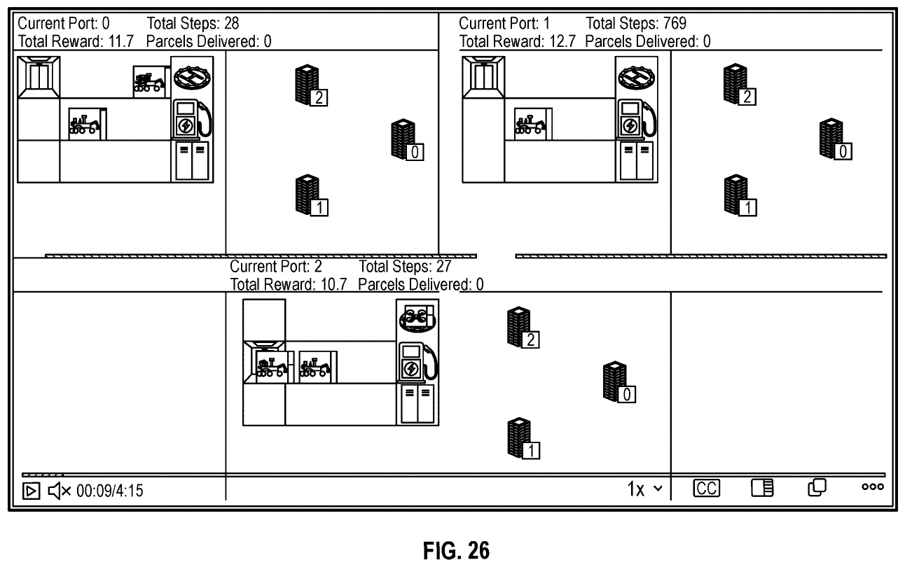

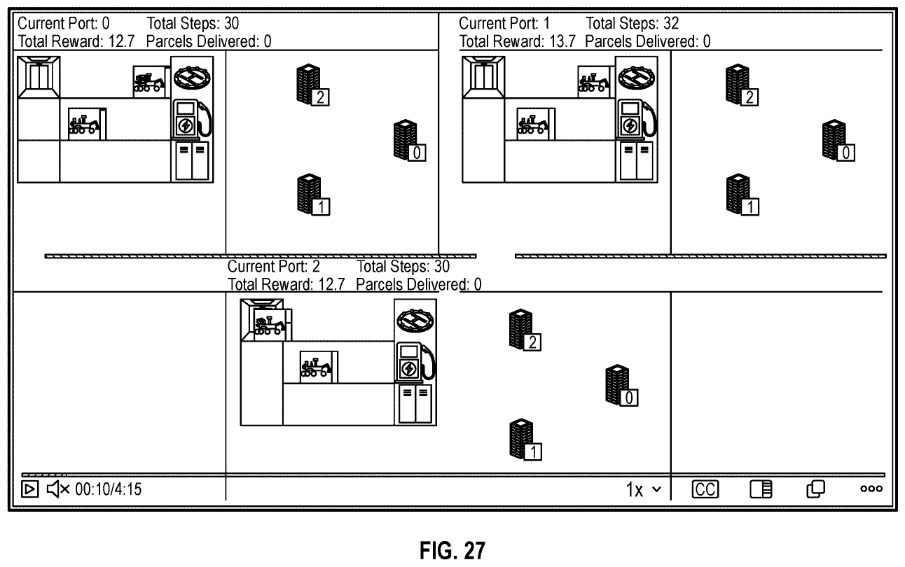

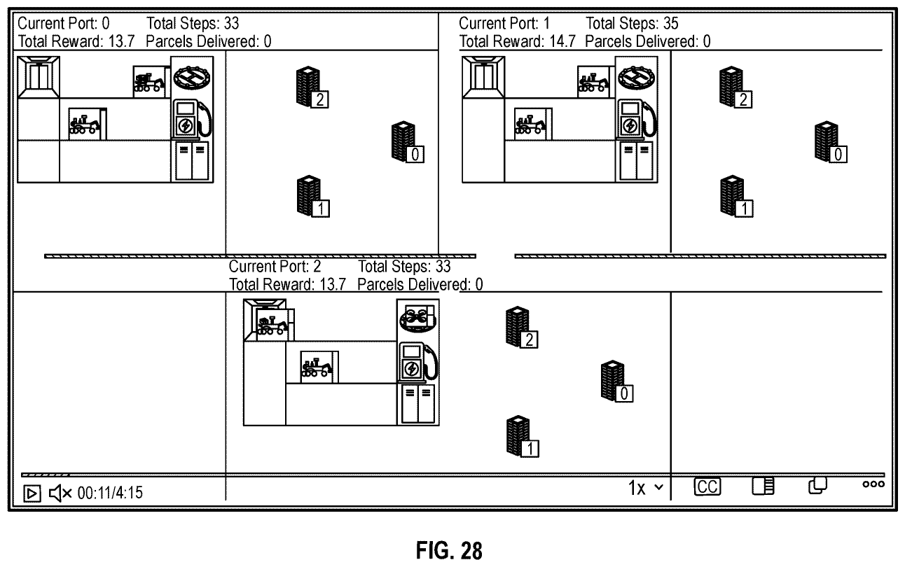

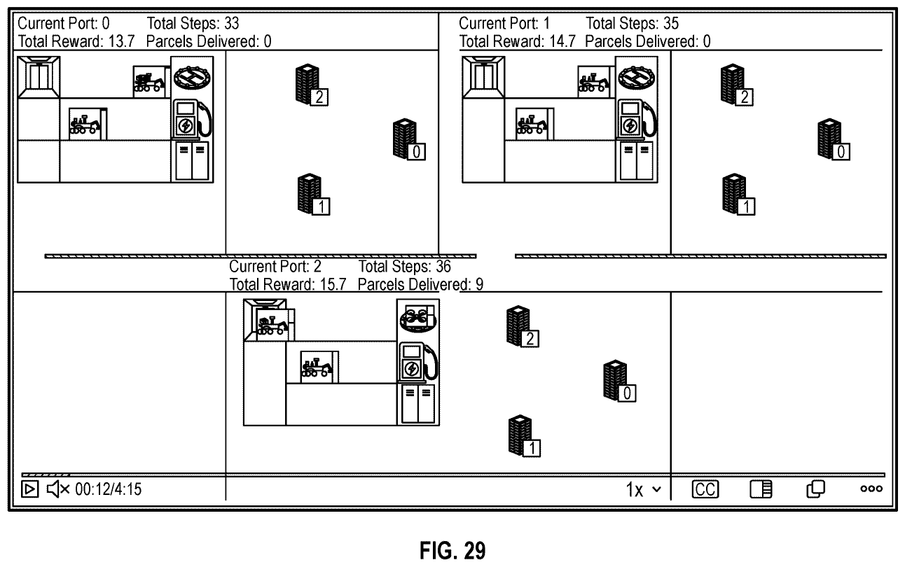

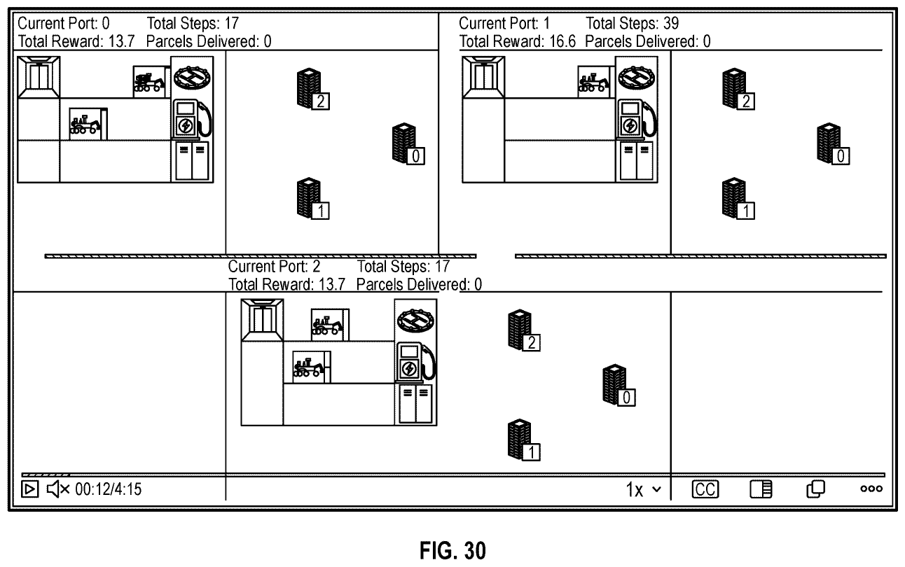

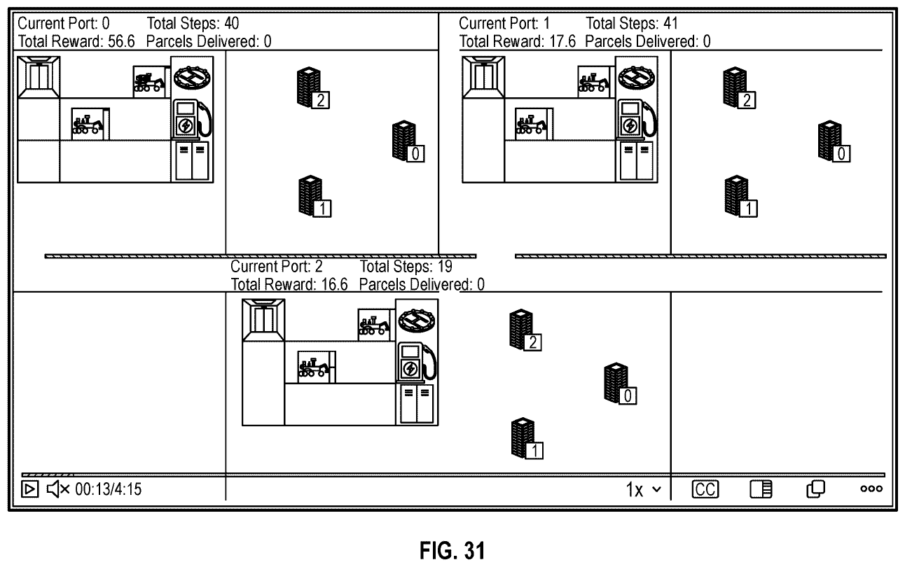

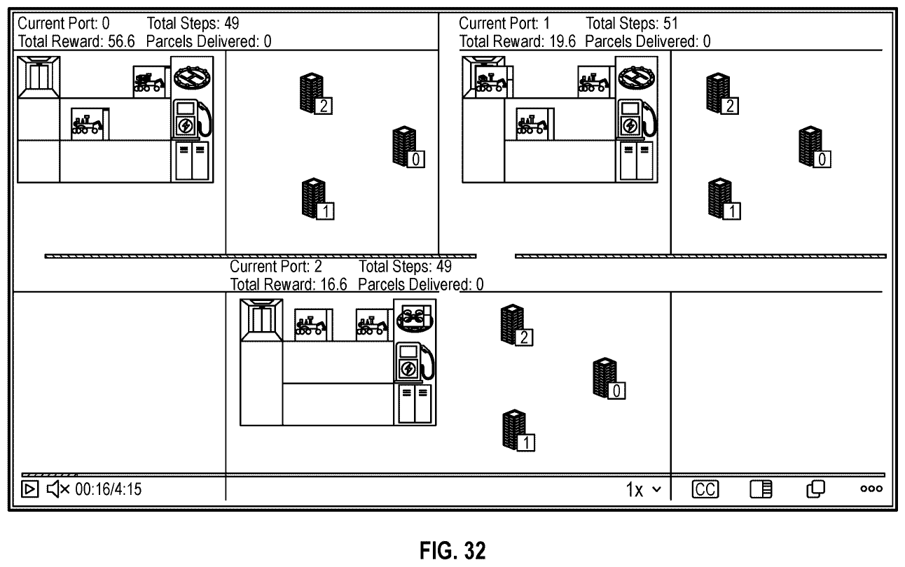

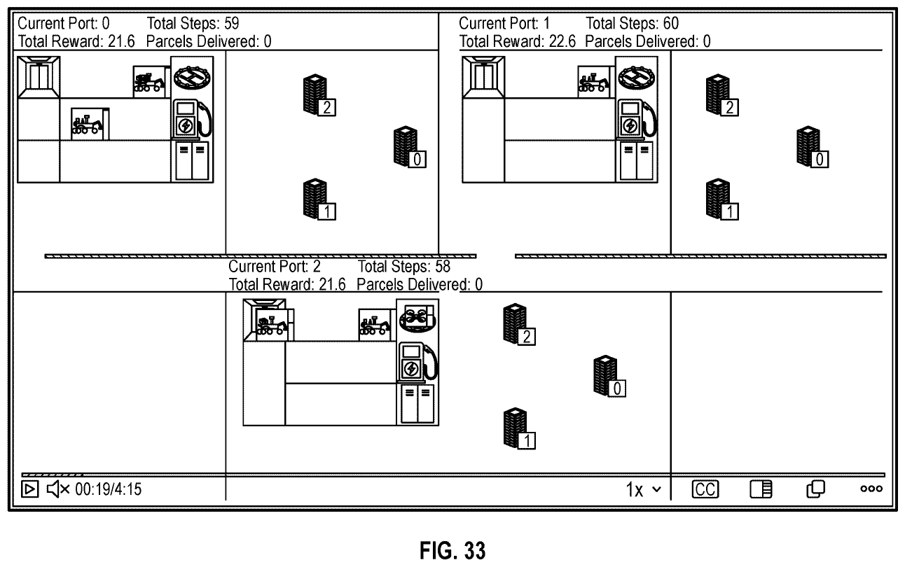

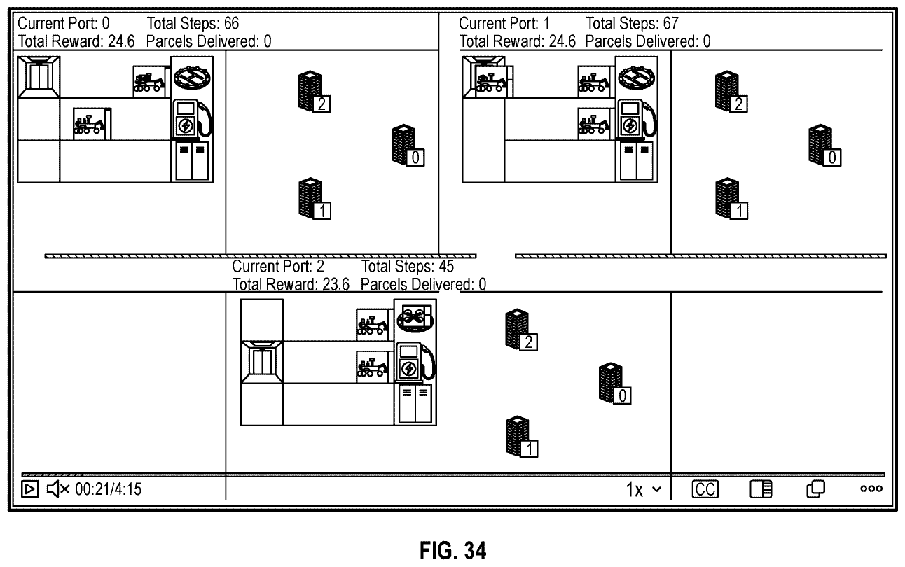

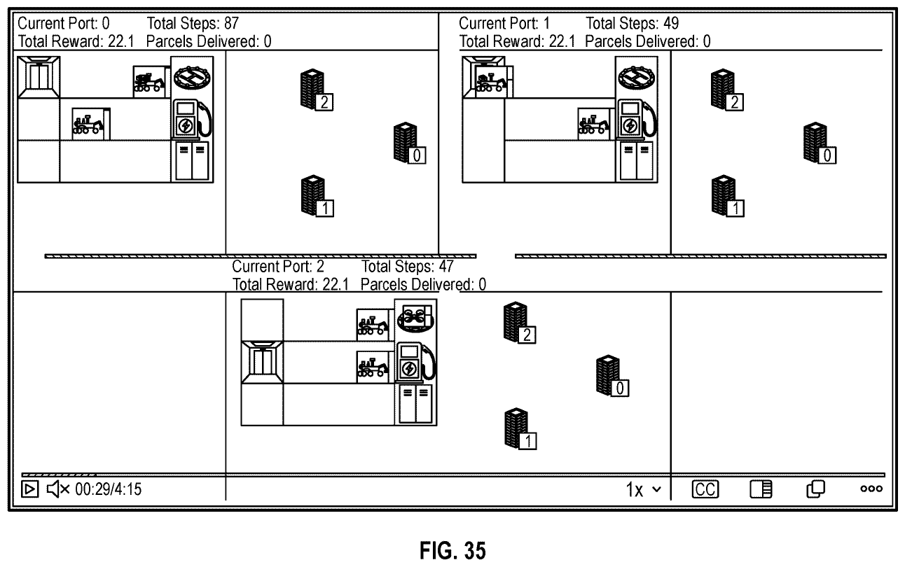

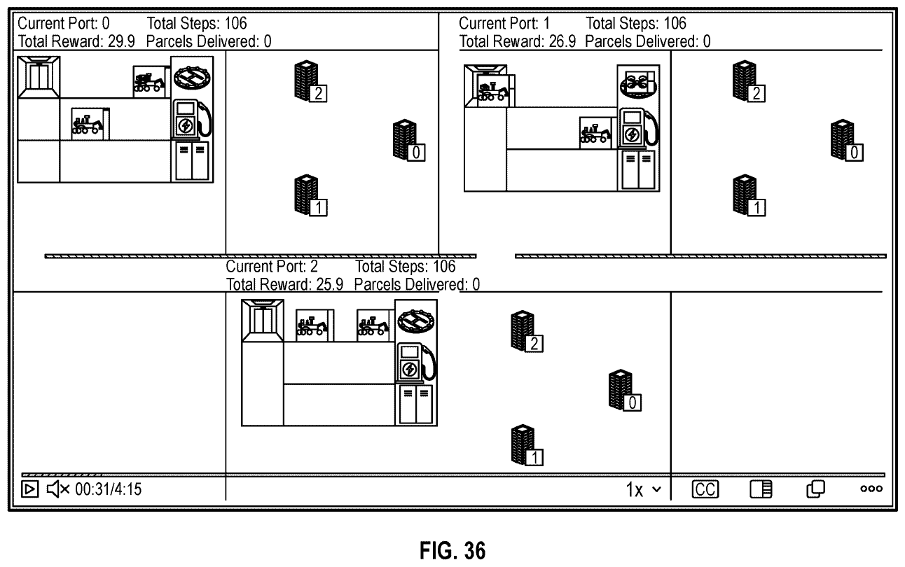

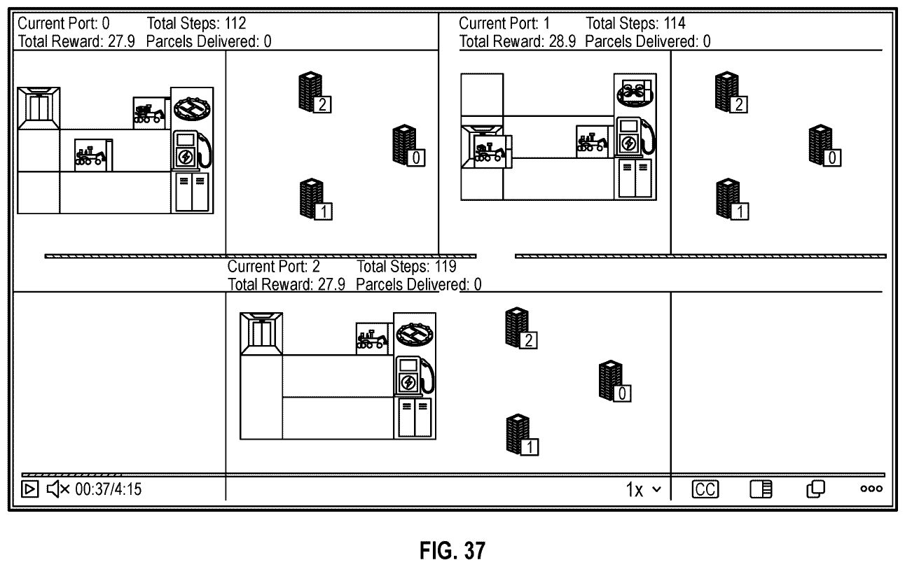

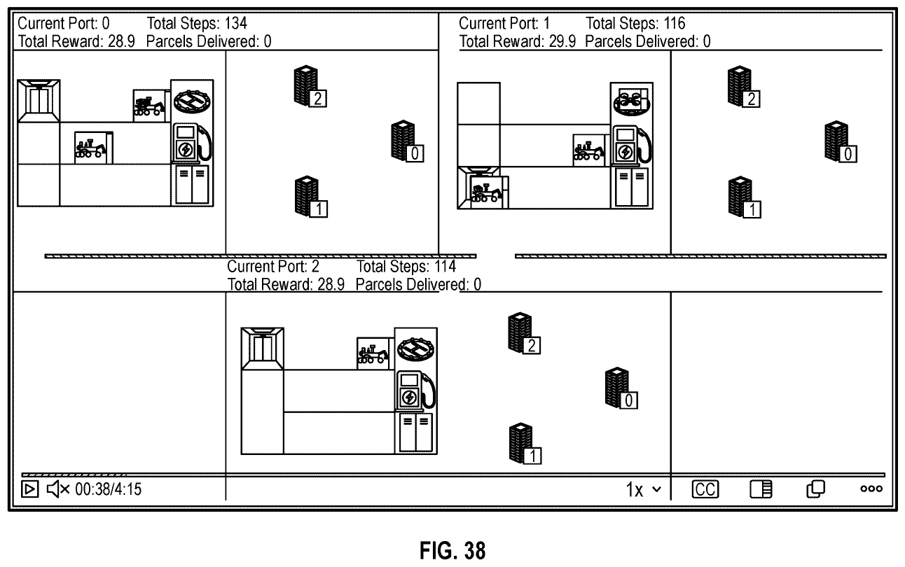

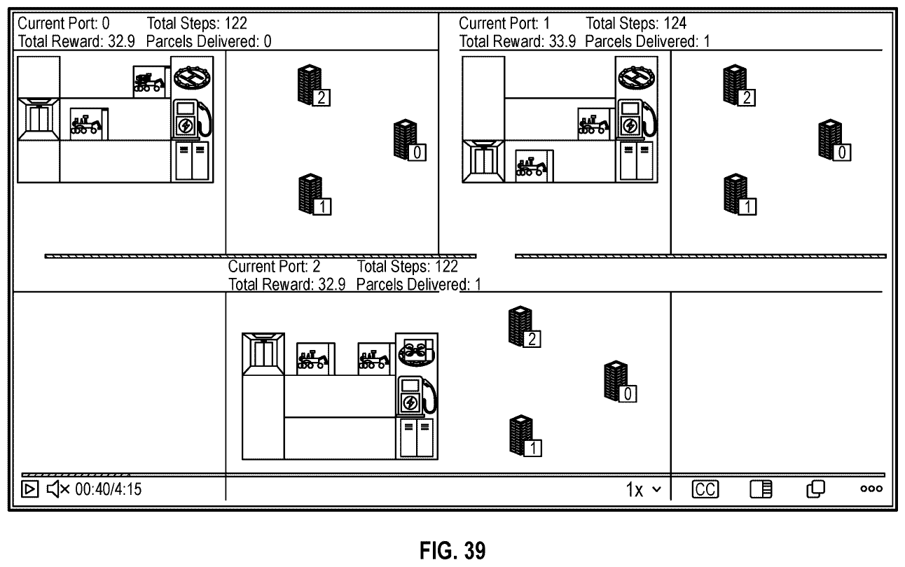

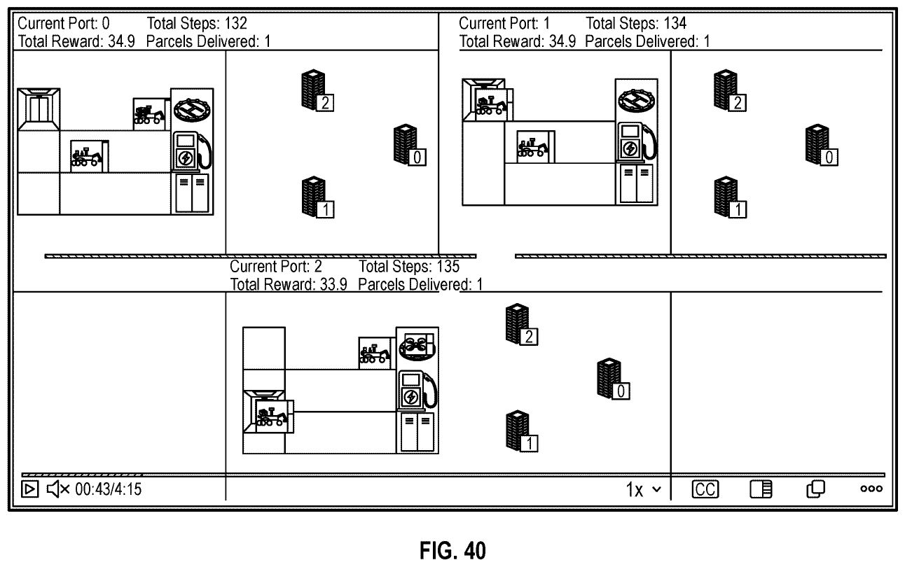

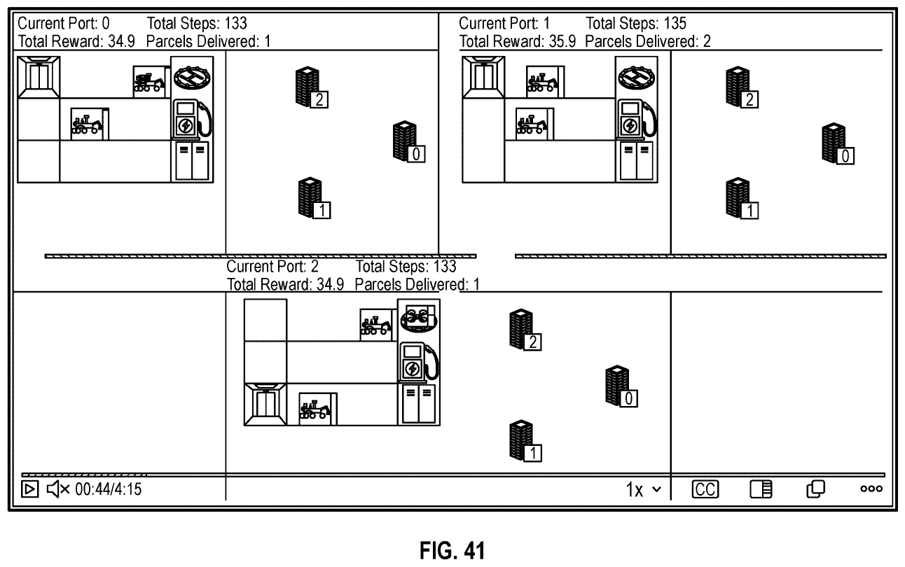

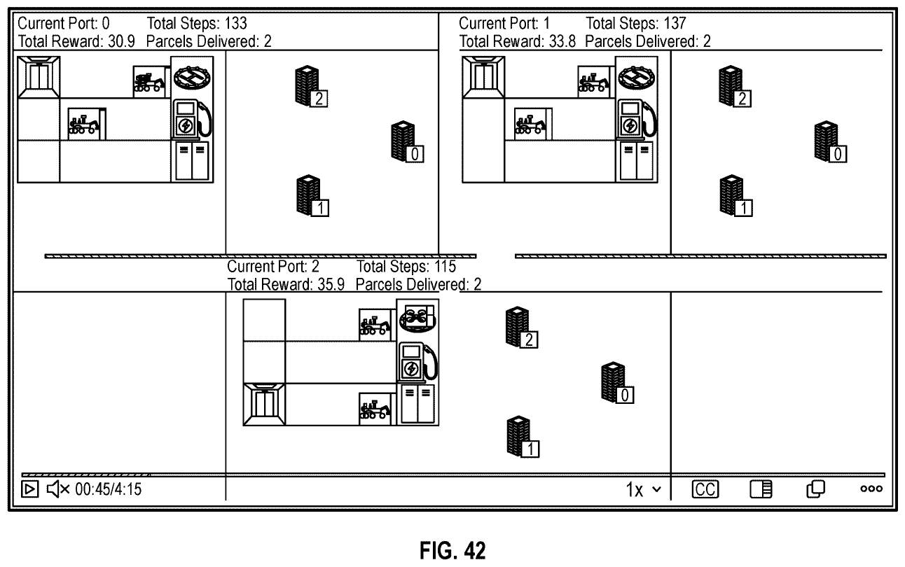

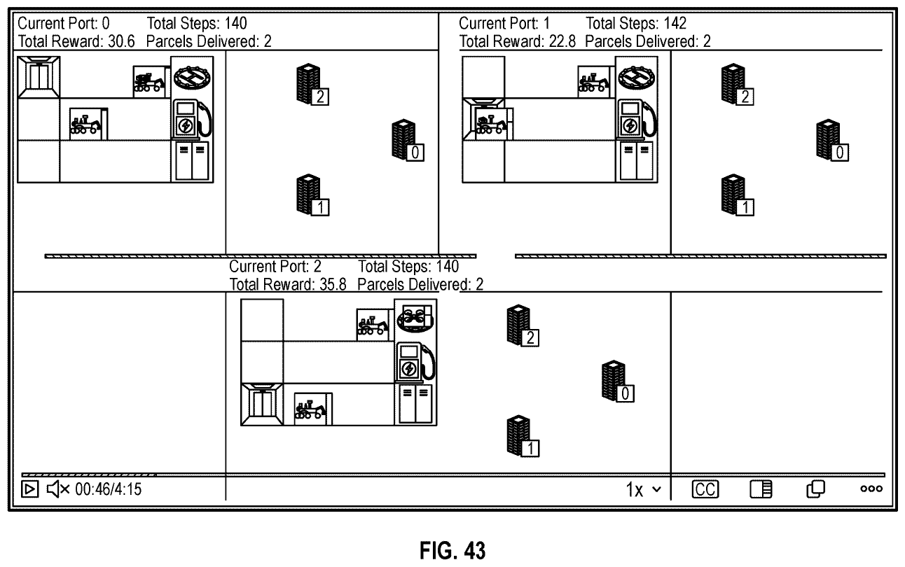

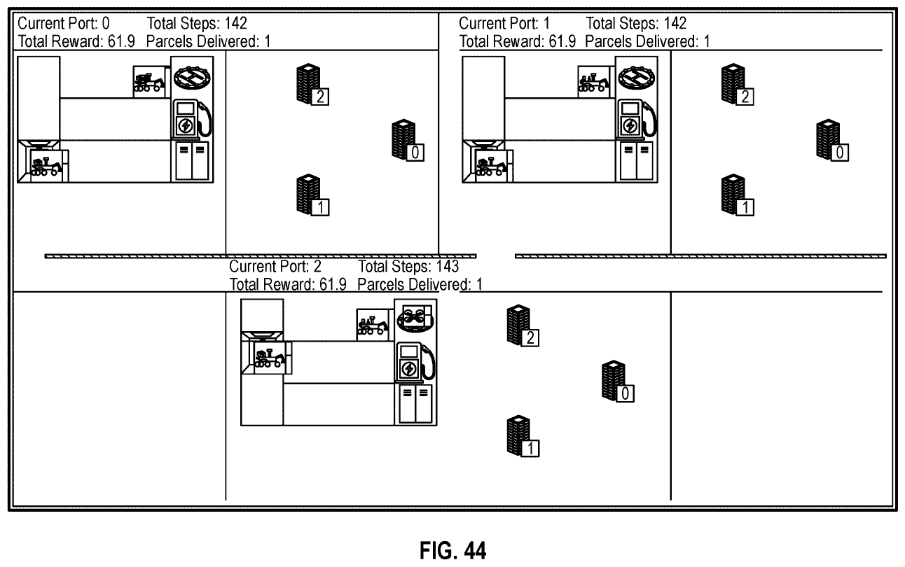

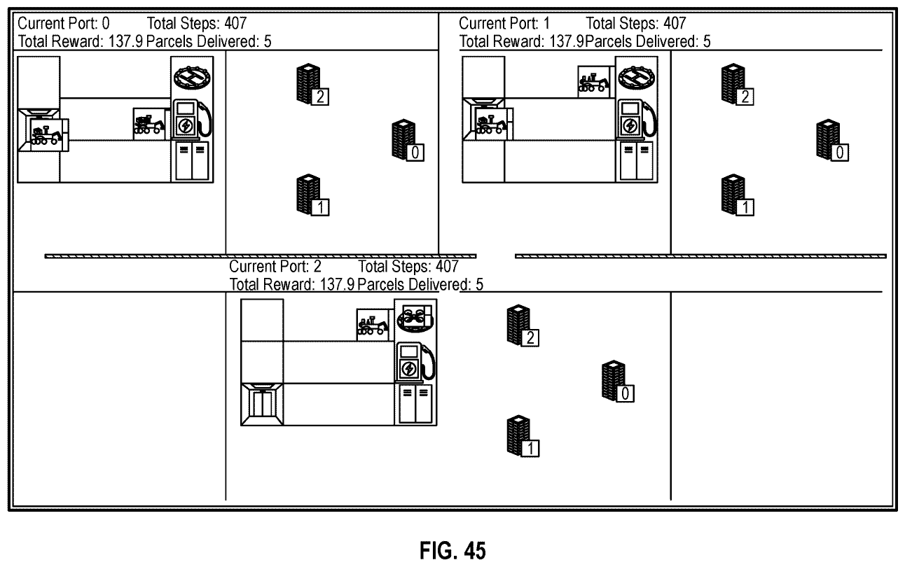

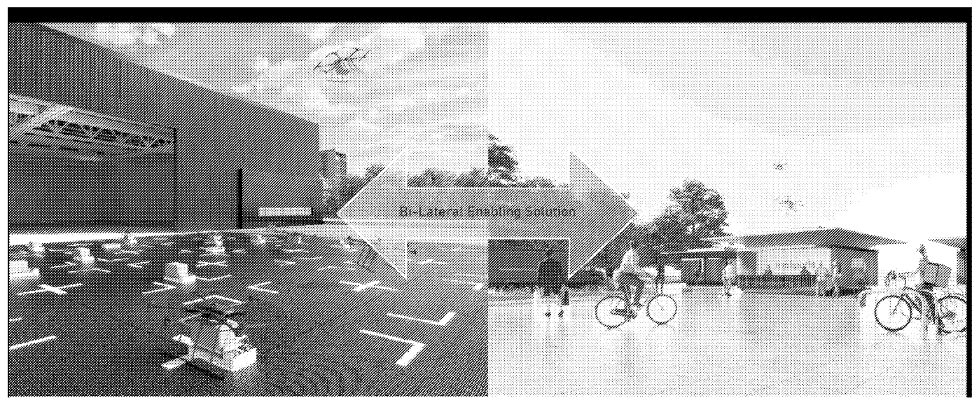

The base of all the rover robots comprises:
at least one chassis 13,
at least 4 wheels, that are preferable meccanum wheels so as to provide omnidirectional movement 14,
at least 4 motors driving the wheels 15,
at least 4 motor drive electronics 16,
at least one high end computer processing unit able to process on board sensors and communicate with collaborative server high level commands 17,
at least one camera, preferably a plurality of cameras, 18,
at least one depth or stereoscopic depth sensing sensor 19,
at least one battery and battery management system 20,
at least one processor and software to provide low level control of the mecanum motors and wheels 21, and
at least one wireless communications to the collaborative server 22

FIG. 6 shows the drone garaging rover.

The drone garaging rover comprises
a rover base,
at least one linear actuator to lift the drone off the ground 23,
at least one Software application to be able to use information from location sensing and cameras to locate the rover under the drone to be garaged,
at least one software application able to perform the navigation of the drone port using feedback from location sensing and local sensing following commands from the collaboration server, and
at least one visual marker or energy transmit receive beacon 24 for detection by a remote sensor receiver transmitter for the purpose of rover location and orientation measurement.

FIG. 6A shows the drone lifting actuators down, FIG. 6 B shows the drone lifting actuators raised so that the drone would be off the ground;

FIG. 7 shows the parcel loading and lockering rover.

The parcel loading and lockering rover PLLR is required to move a parcel from one place in the drone port to another place in order to locker the parcel or load the parcel into the drone. It must also be able to go under a drone carrying a parcel and allow the drone to drop off the parcel onto the rover.

The top panel of the PLLR is where a parcel can sit.

This top panel is actuated to raise or lower during loading or unloading of parcels.

The PLLR comprises the standard rover base plus
at least one linear actuator 26 to raise or lower the top panel 25 of the rover,
at least one linear actuator to push the parcel off the top panel 27,
at least one Software application to be able to use information from location sensing and cameras to locate the rover under the drone which is holding onto a parcel,
at least one Software application to be able to use information from location sensing and cameras to locate the rover under the drone which is waiting to receive a parcel,
at least one software to control the raising and lowering of the top panel linear actuator so that the top panel comes in contact with the parcel to be dropped off,
at least one software to control the raising and lowering of the top panel linear actuator so that the parcel sitting on the top panel comes is placed into the drone parcel holding mechanism,
at least one software to control the push off linear actuator such that the parcel falls off the end of the top panel onto the required place, and
at least one software application able to perform the navigation of rover around the drone port using feedback from location sensing and local sensing following commands from the collaboration server.

The parcel pickup rover, PPR, in FIG. 8, is required to collect parcels placed on the top floor when winched down from a drone, or to pick up a parcel left on the ground under any other circumstances.

The PPR is made up from the standard rover base plus
at least one top panel (25),
at least one gradient wedge 26 onto which a parcel can be pulled off the floor and onto the rover,
at least one linear actuator to push the parcel off the top panel 27,
at least one linear actuator to raise or lower the at least one linear actuator to push the parcel off the top panel 28,
at least one rotary and linear actuated arm 29 that can place its end hand behind the parcel to be picked up so as to block the parcel from moving,
at least one software application to be able to position the PPR in front of the parcel to be picked up,
at least one software application which with feedback sensed data can extend and rotate the at least one rotary and linear actuated arm in order to place the arm hand 30 behind the parcel,
at least one software application which with feedback sensed data can extend the at least one linear actuator to push the parcel off the top panel, so that the end of the actuator contacts and pushes the parcel and causes it to pivot about the rear of the parcel, and
at least one software application which regulates the extension of the at least one linear actuator to push the parcel off the top panel, the at least one rotary and linear actuated arm and the rover position so that the parcel is pulled onto the rover by way of the gradient wedge in a combination of actions.

In a slightly different embodiment, the PPR uses at least one conveyor belt to engage with specific catch points on the parcel and to load the parcel by pulling it onto the top panel by way of the conveyor belt which lies the length of the rover.

At least one software application is able to perform the navigation of rover around the drone port using feedback from location sensing and local sensing following commands from the collaboration server

At least one software application pushes activate the mechanisms such that the parcel can be pushed off the rover when at the correct place to do so.

The invention requires means for location of items within the port for the purpose of locating and also directing movement.

FIG. 9 shows a view of the drone port roof top.

The roof top 31 has at least one post 32 on which is placed at a set height at least one sensor 34. The at least one sensor can comprise at least one camera looking down onto the roof, or at least one beacon receiver transmitter. The beacon could use ultrasonic energy or radio frequency electromagnetic energy with which to sense, receive, transmit. Such beacons are available and are called ultrawideband beacons. An item on the roof top, such as a parcel or drone or rover can be demarked with at least one visual marker 35 such as an April Tag or Aruco Marker. The marker can be seen by the at least one camera and by processing the video frames data, the location and orientation of the marker can be distinguished in relation to the camera. If the camera is calibrated with a known root position on the roof top or other platform, the location of the marker on the item relative to the root position can be inferred from the available information.

In this invention the cameras are supported by at least one local computer such as a raspberry Pi, and the computations of the April tag pose are made using at least one software application to perform the pose estimation. When the pose estimation is sent to the collaborative server the pose can be combined with the calibration pose by at least one software application designed for this purpose and therefore this application can use data from any camera, generate multiple estimates of the item marker relative to the calibration pose and a average estimate of location and orientation generated ad broadcast for use in several other applications.

In the location process several cameras for example camera 1, 2, 3, can be used.

To define a root or origin coordinate, an April tag is placed at a unique place A in the drone port. The nearest camera uses the April tag pose detection algorithm to calculate a matrix transformation T1-A, where this implies transformation of camera 1 for the origin point A.

The matrix transformation comprises a 4×4 matrix with 3×3 rotation matrix in top left, 1×3 translation matrix column on the right and 0,0,0,1 in the bottom row.

To calibrate camera 2 an April tag is placed at a point B where it can be seen by both camera 1 and camera 2. This provides two transforms T1-B and T2-B. From these we can calculate a new transform T¹₂. If an April tag is randomly placed in only the view of camera 1, then we use T1-A and the pose for the randomly placed tag to calculate its position relative to A.

If an April tag is randomly placed in only the view of camera 2, then we use T1-A, T¹₂ and the pose transform for the randomly placed tag to calculate its position relative to A.

Similarly, to calibrate camera 3 an April tag is placed at a point C where it can be seen by both camera 2 and camera 3. This provides two transforms T2-C and T3-C. From these we can calculate a new transform T²₃.

If an April tag is randomly placed in only the view of camera 3, then we use T1-A, T¹₂, T²₃ and the pose transform for the randomly placed tag to calculate its position relative to A.

An item on the roof top, such as a parcel or drone or rover can be demarked with at least one ultrawideband marker 36 such that the relative position and orientation of the ultrawideband marker can be calculated. Such off the shelf ultrawideband market systems are available, and they perform the calculations and cand send the results to the collaborative server or to any robot in the system.

At least one other visual marker can be distributed around the drone port such as 37. A rover may for example use its at least one camera to see the marker and since the location and orientation of the at least one other visual marker is defined in a database accessible by the rover computer, the rover can use the pose estimation method to calculate its own location and orientation relative to the at least one other visual marker and thereby locate itself in the port.

FIG. 10 shows the graphical interface used to show what is happening to the simulated robots and AI. In this image the simulation has just started.

FIG. 11 shows the simulation after nine parcels have been delivered.

The simulation allows for another software, the deep reinforcement learning AI module, DRAI, to provide commands to these simulated robots and for the DRAI to receive status information back about the status of the robots in simulated real time. In computer science the DRAI is termed the agent. The high fidelity simulation of the drone ports results in status data that in computer science is termed the environment.

Using unsupervised deep reinforcement learning the DRAI performs exploration in order to learn the correct relationship between the status and the commands such that during an exploitation phase the DRAI can accurately operate all drone ports and the robots in a collaborative and optimal manner so as to perform parcel delivery in the shortest time.

The DRAI training framework uses a reward and penalty system to achieve this carrying out many thousands of simulations until the DRAI can operate the drone ports with maximum reward and minimum penalty.

Deep reinforcement learning assumes that the environment can be modelled as a Markov Decision Process. This means that any command generated by the DRAI is dependent only on the current environment status, which is the status of the drone port simulation. Therefore environment states include all the necessary values that allow the DRAI to learn without need for memorized states.

FIG. 12 shows an agent's typical network of weights which are learned during the DRAI training.

Although embodiments of the invention have been described by way of illustration, it will be understood that the invention may be carried out with many variations, modifications, and adaptations, without exceeding the scope of the claims.

### EXAMPLE 1

Typically, in our four-drone port simulation, there are around 70 inputs to the input layer, coming from robot and parcel status, the environment. There are two middle layers of weights which are modified during the exploration run for four drone ports.

The weights illustrate the matrix coefficients which multiply the inputs via the input layer, multiply again the results by the middle layers, and finally to create the outputs via the output layer.

Typically, in the four-drone port simulation we have around 20 outputs corresponding to commands that are given by the DRAI to the simulator.

As the learned information is described by the weight values in the two layers and as the implication of the value of the weight is difficult to interpret, although the DRAI may accurately deliver the CS function, we cannot explain in human terms the decision-making logic.

Given the safety requirements of such a system operating in the real world, and requiring CAA regulatory approval, in this invention we can guarantee that the system is safe by ensuring that at least one high fidelity simulation of the drone ports and included robots is used to train the DRAI, where this simulation is validated against observed data from at least one real life drone port with real-time real-life robots being provided with exactly the same test commands as the simulation robots.

Thus, the real-world sensor data in the real-world environment that results from the 20 or more commands is used to check like for like the simulated sensor data created in the simulation. By ensuring the simulated sensor data is the same as the real-world data the simulation can be validated and any discrepancies can be removed.

To provide added safety verification the DRAI performance can be tested by running the simulation with a very large number of different initial conditions and changes in robot performance in order to prove that no unsafe situations occur. The simulation can be run for the equivalent of several years and errors detected. Errors would include the detection of robots running out of charge, the usage per hour of a robot rising beyond its operating envelope, parcels arriving to the wrong destination, parcels not being delivered, robots not being used at a reasonable minimum usage level. Several other tests would be applied beyond these mentioned.

In the second means of verification, one can extract the pathways that are represented by the weights relating input status to output command.

For each of the 20 or more command outputs from the DRAI we randomly sample the different sets of robot simulation environment input states that causes the triggering of the commands. These input states can be represented using an English text description and can be coded so as to be human readable.

Thus, a typical result for one command and one set of input states may read:—

IF LIFT IS AT GROUND FLOOR AND ROVER IS AT LIFT DOOR ON ROOF TOP AND PARCEL MUST BE LOCKERED THEN SEND LIFT TO TOP FLOOR.

The above description example would in reality be much longer incorporating all relevant status terms.

The samples set of unique descriptions of the network can be delivered for human validation. Although many hundreds of such descriptions are generated, within a short time, a team of humans can check that all are safe and valid.

Due to limitations in the DRAI method, some commands may seem illogical to a human, however as long as they are not unsafe and do not waste time to achieve a correct overall result, they can be acceptable.

If an unsafe decision is identified, this will be very rare since a long-term simulation should have identified it. However to fix the issue one can modify the reward or penalty definitions in order to impact this behavior and thereby remove the possible unsafe logic, alternatively the exploration phase may be run for a longer time.

In an associated process one can repeat the DRAI training process but with slightly different reward and penalty definitions as well as random initial conditions. As a result, we can arrive at more than one version of the DRAI. Each of these DRAIs will have very slightly different weights but in theory should provide the same command for a given drone ports status.

With multiple DRAI CS decision makers one can run them in parallel.

This allows the invention to be broadened to create a system with inbuilt redundancy or with majority voting of commands to be used for a given status input.

The collaborative server hardware may comprise one or more of the following:
at least one high power processing unit preferably including at least one calculations accelerator hardware support;
at least one communications support to receive and send data to (all) drone ports;
at least one operating system;
at least one user interface; and/or
at least one power unit.

### To Create the DRAI

At least one deep reinforcement learning framework is required with at least one deep reinforcement trained agent and at least one high fidelity simulation of drone ports and associated robots the status of which is equivalent to the environment required by the deep reinforcement learning

When operating so as to coordinate collaborative operations between all robots and drone ports, the collaborative software comprises at least one decision making software that accepts as inputs the state of the drone ports and calculates the high level commands to send to each robot in each drone port.

The at least one decision making software is comprised of any mix of one or more of:
at least one deep reinforcement artificial intelligence network that has been trained exhaustively using a near exact digital twin simulation of the drone ports that it will serve,
at least one deep reinforcement artificial intelligence network that has been trained exhaustively using a near exact digital twin simulation of the drone ports that it will serve, with additional training under many different initial conditions and robot behavior,
at least one deep reinforcement artificial intelligence network that has been trained exhaustively using a near exact digital twin simulation of the drone ports that it will serve, with additional training under many different initial conditions and robot behavior and which has been safety verified by long term in simulation testing with extra fail detection software,
at least one deep reinforcement artificial intelligence network that has been trained exhaustively using a near exact digital twin simulation of the drone ports that it will serve, with additional training under many different initial conditions and robot behavior and which has been safety verified by human verification of a very large sample of decisions made during a long term in simulation testing, where those decisions are exported in a human readable format for further checking, and
at least one decision making software application based on a plurality of deep reinforcement artificial intelligence networks that has been trained independently and exhaustively using a near exact digital twin simulation of the drone ports that it will serve, with additional training under many randomly chosen different initial conditions and robot behavior and where the final decision is based on a type of majority voting system between the plurality of command outputs and where the decision making software has been safety verified by long term in simulation testing with extra fail detection software and has been safety verified by human verification of a very large sample of decisions made during a long term in simulation testing, where those decisions are exported in a human readable format.

The following provides more information as to the development work carried out to implement and test the invention.

### Reinforcement Learning

In recent years with increasing compute power, reinforcement learning has been used to solve problems that were previously deemed too difficult for humans or even computers to tackle. Some examples use cases of reinforcement learning are AlphaGo which managed to beat a Go professional player and AlphaFold which was able to predict a protein's 3D structure from its amino acid sequence. It was reported that Amazon has leveraged the capabilities of reinforcement learning algorithms to optimize their warehouse and logistics operations.

To put a definition to reinforcement learning, it is a type of unsupervised learning where the algorithm has to find the most optimal solution to its task without any input from the user. The following figure depicts an overview of what a generic reinforcement learning setup will look like:

### In FIG. 13

In the diagram above, the algorithm which has to find the most optimal solution is called an agent. The environment is where the agent lives in and interacts with. For every action that the agent performs, the environment will give a reward and inform the agent what is the state of the environment that it is currently in. The reward given can be positive or negative depending on whether the agent has performed an action that will benefit or set itself back. You can think of the reward system like a carrot and stick approach.

### Objective Function

The objective function is used to maximise the reward. In the case of controlling the drone port network, a reward is given whenever the agent is able to deliver parcels from one drone port to another correctly i.e the right address. Besides that, the rewards obtained at the very end of a learning cycle (or episode) reduces as the learning cycle (or episode) gets longer. These methods guarantee that the agent will deliver a parcel from one drone port to another in the most efficient way since the agent will try to maximise its reward.

### Software Tools Use

All development is done using Python 3 on a Linux and Windows platform. The libraries that were used are OpenAI Gym, which provides the structure that is needed to implement the drone port network environment, and RLLib which has many reinforcement learning algorithms which can be easily plugged into the drone port network environment.

Statement of Which Robots were Considered

The robotic systems that are considered in a drone port are:
1. Lift
2. Garaging Rover
3. Parcel Rover
4. Drone

### Here We List the Different Possible Tasks it is Assumed Each Robot can Perform

Lift
   Move to floor N (where N is the amount of floors there are in a drone port. If N is 4, there are 4 possible actions which the lift can perform.)
Garaging Rover
   Idle
   Pick Up Drone
   Put Down Drone
   Go To Lift
   Go To Charging Station
   Go To Takeoff Location
   Enter Lift
Parcel Rover
   Idle
   Pick Up Parcel
   Put Down Parcel
   Go To Lift
   Go To Charging Station
   Go To Takeoff Location
   Go To Parcel Locker
   Enter Lift
Drone
   Idle
   Fly

### How This is Represented in Open AI Gym

To conform to OpenAI Gym environment standards, actions of each robotic components must be modelled using one of the following data structures:
Discrete
   Agent can take one action at each timestep
Multi-Discrete
   Agent can take multiple actions at each timestep
Tuple
   A data structure to encapsulate simpler actions
Dictionary
   A data structure to helped group actions together in a dictionary format
Box
   A data structure that is like an array but has bounds.
Multi-Binary
   A data structure which is similar to one-hot encoding

At the beginning, the actions were modelled using Multi-Discrete. However, the amount of actions possible for each time-step will exponentially increase when we introduce more robots. This makes the agent harder and longer to find the most optimal solution. As a result, the actions of the robots were modelled using Discrete.

### How Task Time is Simulated

Task time is simulated using time-step, the atomic unit of time in the reinforcement learning environment. So each task time will take a certain amount of time-step.

Additionally, time-step is an arbitrary value that can be easily translated into actual time taken for specific actions.

### How Ground Robot Power Levels are Simulated

At the beginning of each simulation or episode, all the ground robots start with full charge. To simulate real-life scenarios, an artificial charge and discharge rate were introduced for all robots. The batteries discharge via idling or by performing an action. The discharge rate set for idling is lower as compared to the robot performing an action. The charge and discharge rate depend on the time-step of the environment which can be easily changed and defined to reflect much more closely to a real-world situation.

### How Drone Flight Time or Distance Travelled is Dealt with and Power Consumption

It is assumed that all drones fly at the same speed, thus the varying factor will be flight time. Similar to the case of ground robots, power consumption of drones depends on the flight time which in turn depends on the time-step of the environment which can be easily defined by the user.

### The Penalties or Rewards Applied

There are several penalties applied in the environment:
1. Repetitive movements i.e agent moves the rover back and forth
2. Agent delivers parcel to the wrong destination
3. Robot charge level drops to 0
4. Moving lift without anything inside the lift

These penalties are applied so that it discourages the agent from doing such actions in the future.

The main reward given is when a parcel is delivered from a drone port to another drone port (the drone port the parcel is supposed to be delivered to). However, to encourage and speed up learning, smaller rewards are given to the agent for doing tasks that help to run the drone port efficiently. The following are the list of rewards given:
1. Delivering a parcel to the correct destination
2. Charging the drone
3. Moving lift with something inside the lift

### The Steps Required to Achieve a Single Objective in Human Terms

For a human to deliver a parcel from one drone port to another:
1. Garaging rover takes a drone from the charging station.
2. Lift goes to the charging station's floor
3. Garaging rover enters lift
4. Lift goes to the roof-top
5. Parcel rover goes to parcel lockers and collect a parcel
6. Lift goes to the parcel lockers' floor
7. Parcel rover enters lift
8. Lift goes to the roof-top
9. Parcel rover loads parcel

This shows the logic sequence is deep and multi robot in parallel.

### The Challenge of the 2 Drone Simulation

When2 drones are operating in parallel, the action space and observation states gets larger which in turn increases training time and complexity.

### How a Learning Cycle is Started

Whenever, the agent enters into a terminal state (where either it managed to deliver all the parcel or it has entered into a very undesirable state), the total reward is calculated and the next episode starts. If the episode length got too long, the episode will end and the total reward is calculated and the next episode starts.

Here is a graphic of the learning reward, penalty against steps taken, so we can visualise that the reward is growing.

### FIG. 14

Reward received by the agent in a 2 drone port network, where there is one drone in the entire network and there is 1 parcel rover and 1 garaging rover in each drone port.

Reward received by the agent in a 3 drone port network, where there is one drone in the entire network and there is 1 parcel rover and 1 garaging rover in each drone port. The maximum rewards for both drone ports are different as there are more parcels to deliver in each training iteration.

### When to Stop Learning and Why

As with all reinforcement learning algorithms, there is no one-rule-fits-all on when to stop training. However, the rule of thumb to when to stop training will be when you start noticing the highest and mean rewards obtained by the agent starts to plateau. When this happens, it usually means that the agent has learned a policy to maximise your rewards.

Here follows an explanation of what happens during a typical simulation.

### FIG. 15.

There are 3 drone ports

Port 0, 1 and 2, top left, top right, bottom middle.

There is only one drone in this simulation currently on the roof of Port 0.

On the top floor is the take-off pad

On the middle floor is a garaging rover which is used to collect drones and bring them for charging at the charging station on the middle floor left

On the ground floor are the locker, right hand side.

The lift allows transit between floors

### FIG. 16

The parcel rovers of Port 0 and 1 go to the lockers.

Port 0 has 4 ready to send

Port 1 has 1 ready to send.

Port 2 has 1 ready to send.

### FIG. 17

Port 2 rover also goes to the locker to collect a parcel

### FIG. 18

Port 0 rover moves towards lift

### FIG. 19

Port 1 lift is called to ground floor

Port 0 rover waits for lift

### FIG. 20

Port 0 lift going down

Port 1 lift at ground floor

Port 2 rover waiting for lift

### FIG. 21

Port 0 rover in lift,

Port 1 rover in lift

Port 2 lift called going to ground and rover waiting

### FIG. 22

Port 0 lift going up

Port 1 waiting for rover to enter lift

Port 2 rover going into lift

### FIG. 23

Port 0 lift at top floor and rover leaving lift going out to the drone

Port 1 lift going up

Port 2 rover going into lift

### FIG. 24

Port 0 rover loading drone with parcel

Port 1 lift going up

Port 2 lift about to start going up

### FIG. 25

Port 0 drone about to take off

Port 1 rover with parcel at top floor, rover exiting lift

Port 2 lift going up

### FIG. 26

Drone leaves Port 0 in the direction of Port 1

### FIG. 27

Drone arriving at Port 1, landing at port 1

### FIG. 28

Drone drops parcel at port 1

### FIG. 29

Drone takes off from Port 1 in direction of port 2

### FIG. 30

Rover collects parcel dropped off at port 1

### FIG. 31

Port 2 parcel rover getting towards the take off area

Parcel loaded onto to the incoming drone on Port 2

### FIG. 32

Port 1 parcel being taken to lift to go down to locker

Port 2 the garaging rover is going to the lift because the drone is low on charge, see yellow bar at drone right bottom.

### FIG. 33

Garaging rover on Port 2 going to collect drone

### FIG. 34

Garaging rover entering lift having picked up the drone

### FIG. 35

Drone now taken to get charged

### FIG. 36

Drone fully charged

### FIG. 37

Drone taken to take off pad

### FIG. 38

Port 1 parcel rover taking parcel to locker

Port 2 drone on take off pad

### FIG. 39

Port 2 parcel rover loads drone with parcel

Port 2 parcel rover collects parcel delivered

Drone takes off,

Port 1 parcel nearing locker

### FIG. 40

Port 2 parcel rover takes parcel to lift and to lockers

### FIG. 41

### FIG. 42

### FIG. 43

It can be seen that a complex sequence of parallel and collaborative tasks are being performed by the lift, the garaging rover, the parcel rover, the charging and the drone.

### FIG. 44

During this project, the algorithms PPO, APPO, IMPALA and APE-X were all tested. Amongst these, APPO was by far the best performing. PPO also performed well. However is not a particularly high throughput architecture, meaning it took longer to run than any of the others mentioned.

APPO is an asynchronous variant of Proximal Policy Optimization (PPO) based on the IMPALA architecture. This is similar to IMPALA but using a surrogate policy loss with clipping.

Other architectures were successful, however APPO proved a good option due to requiring minimal hyperparameter search and its fast training on multiple cores.

1. A drone (or unmanned aerial vehicle, UAV) port comprising:
(a) one or more (such as a plurality or a set of) mobile or transport robot(s) (or rovers);
(b) a drone/UAV landing, take-off or drop-off (LTD) area or zone;
(c) optionally, one or more lifts(s);
(d) one or more corridor(s) or transport channels and/or a (multi-level) network, optionally comprising:
(i) one or more substantially vertical channels (such as a lift shaft) suitable for transport of a drone, preferably to a garaging, charging and/or LTD area;
(ii) a storage area or zone (such as a locker space), suitable for storing one or more (such as incoming and/or outgoing) parcels (or payloads or packages);
(e) a computer and/or collaboration server suitable for communication with one or more robots, corridors and/or drones; and/or
(f) one or more processors and/or sensors, suitable for location, identification and/or tracking of one or more parcel(s) and/or one or more drone(s).

2. A drone port according to claim 1 comprising one or more UAV loading and/or unloading zones or areas.

3. A drone port claim according to claim 1 comprising one or more storage areas for storing one or more parcels and/or one or more drones.

4. A drone port according to claim 1 which additionally comprises one or more charging areas or zones or one or more drones.

5. A drone port according to claim 1 wherein the corridors are substantially horizontal and/or substantially vertical (such as lift shafts).

6. A drone port according to claim 1 which comprises a building.

7. A drone port according to claim 1 wherein the robots and/or drones are substantially automated and/or collaborate with each other.

8. A drone port according to claim 1 additionally comprising more sensors and/or processors, suitable to locate, identify and/or track one or more parcel(s) and/or one or more drone(s).

9. A drone port according to claim 1 wherein at least one robot is able to transport a drone to and/or from a landing/take-off/drop-off (LTD) zone or area.

10. A drone port according to claim 1 wherein a robot is adapted to load and/or unload (or remove) a parcel from a drone/UAV.

11. A drone (or UAV) port comprising at least one transport robot (or rover) that is capable of loading and/or unloading a parcel (or package or payload) onto or from a drone (or UAV) and capable of transporting or moving a drone (or UAV) to and/or from a landing/take-off/drop-off (LTD) zone or area.

12. A drone port according to claim 11 wherein the robot(s) and/or drones are housed or located in a building.

13. A drone port according to claim 11 wherein the robot(s) and/or drone(s) collaborate with each other and/or are automated.

14. A drone port according to claim 11 additionally comprising a computer and/or processor that is able to locate, identify and/or track one or more robot(s) and/or one or more drone(s).

15. A drone port according to claim 11 additionally comprising a storage area for one or more parcel(s) and/or a storage area for one or more drone(s).

16. A drone port according to claim 11 additionally comprising a robot which is able to transport one or more parcel(s) to and/or from a storage area.

17. A drone port according to claim 11 which additionally comprises a drone landing, take-off and/or drop-off (LTD) zone.

18. A drone port according to claim 1 which is modular and/or capable of expansion.

19. A drone port according to claim 1 wherein the robot(s) are automated, collaborate and/or the port is scalable.

20. A drone port according to claim 1 additionally comprising one or more re-charging stations (for a robot or UAV), optionally with an (electrical) power source.

21. A drone port according to claim 1 wherein the robot(s) are artificially intelligent and/or are able to learn and/or train themselves.

22. A drone port comprising one or more robot(s), wherein the or each robot can service a drone (or UAV) and/or transport a parcel (or package or payload) and comprises:
(a) a chassis, suitably with one or more wheels and/or motors;
(b) a camera;
(c) a sensor, for example a visual sensor;
(d) a battery or electrical supply; and/or
(e) a communication system.

23. A drone port according to claim 22 wherein the communication system is wireless.

24. A drone port according to claim 22 comprising a visual marker and/or transmitting/receiving system to allow location and/or orientation of a robot to be determined.

25. A drone port according to claim 22 wherein at least one robot is able to load and/or unload a UAV and/or transport a parcel (or package or payload).

26. A drone port according to claim 22 additionally comprising means to contact, lift or elevate a drone (such as off the ground, for example from underneath).

27. A drone port according to claim 1 comprising at least one conveyer means adapted to push, pull or otherwise move a parcel, for example either towards or away from a robot and/or towards or away from a drone.
